(19) United States
(12) Patent Application Publication
(10) Pub. No.: US 2026/0231239 A1
(43) Pub. Date: Aug. 6, 2026

(54) DETERMINING SUBBAND NON-OVERLAPPING FULL DULEX MODE BASED ON CROSS-LINK INTERFERENCE

(71) Applicant: InterDigital Patent Holdings, Inc., Wilmington, DE (US)

(72) Inventors: Nazli Khan Beigi, Longueuil (CA); Jonghyun Park, Syosset, NY (US); Janet Stern-Berkowitz, Little Neck, NY (US); Paul Marinier, Brossard (CA); Moon IL Lee, Melville, NY (US)

(73) Assignee: InterDigital Patent Holdings, Inc., Wilmington, DE (US)

(21) Appl. No.: 19/149,274

(22) PCT Filed: Feb. 12, 2024
(86) PCT No.: PCT/US2024/015390

§ 371 Date: Jul. 18, 2025

Related U.S. Application Data
(60) Provisional application No. 63/484,798, filed on Feb. 14, 2023.

(51) Int. Cl. H04W 74/0836; H04B 17/318

(52) U.S. Cl. CPC H04W 74/0836; H04B 17/328

(57) ABSTRACT

A wireless transmit/receive unit (WTRU) may select a cell and a synchronization signal block (SSB) associated with the cell, for example based on a reference signal received power (RSRP) measurement. The WTRU may receive configuration information. The configuration information may include a physical random access channel (PRACH) cross-link interference (CLI) threshold and/or one or more time and frequency resources. The WTRU may determine CLI (e.g., a CLI measurement), for example using the one or more time and frequency resources. The WTRU may compare the determined CLI measurement with the PRACH CLI threshold. The WTRU may determine an active mode of operation, for example based on the comparison of the determined CLI measurement to the PRACH CLI threshold. The WTRU may determine the active mode to be subband non-overlapping full duplex (SBFD), for example if the determined CLI measurement is less than the PRACH CLI threshold.

### CROSS-REFERENCE TO RELATED APPLICATIONS

This application claims the benefit of U.S. Provisional Application No. 63/484,798 filed on Feb. 14, 2023, the entire contents of which are incorporated herein by reference.

### BACKGROUND

A wireless transmit/receive unit (WTRU) may receive a configuration. For example, the WTRU may receive configuration information. The configuration information may indicate (e.g., include) a threshold and/or one or more configured resources. The WTRU may measure a cross-link interference (CLI), for example associated with the one or more configured resources. For example, the WTRU may measure the CLI based on the configuration information. The WTRU may determine that the CLI associated with the one or more configured resources is less than the threshold. The WTRU may determine to use subband non-overlapping full duplex (SBFD) operation. For example, the WTRU may determine to use SBFD operation for accessing a cell. The SBFD operation may include selecting a resource from a subband of an SBFD symbol. The WTRU may compare the (e.g., measured) CLI to the threshold. The WTRU may determine an operation mode. The operation mode may be based on the comparison of the CLI to the threshold. The operation mode may be one or more of subband non-overlapping full duplex (SBFD) or non-SBFD. The WTRU may detect one or more synchronization signal blocks (SSBs). For example, the WTRU may detect one or more synchronization signal blocks (SSBs) from a cell. In another example, the WTRU may detect one or more synchronization signal blocks (SSBs) from a cell during initial access. The WTRU may transmit a physical random access channel (PRACH) preamble. For example, the WTRU may transmit a physical random access channel (PRACH) preamble based on the operation mode. The WTRU may send (e.g., transmit) the PRACH preamble using the selected resource. In some examples, the WTRU may determine that the operation mode is SBFD if the CLI is less than the threshold. In other examples, the WTRU may determine that the operation mode is non-SBFD if the CLI exceeds the threshold.

A WTRU may detect one or more synchronization signal blocks (SSBs) from a cell. The WTRU may receive configuration information. The configuration information may include an indication of a cross-link interference (CLI) threshold. The WTRU may determine a CLI associated with the cell. For example, the WTRU may determine the CLI associated with the cell based on the configuration information. The WTRU may compare the determined CLI (e.g., CLI measurement) to the CLI threshold. The WTRU may select one or more resources, for example, based on the comparison of the determined CLI measurement to the CLI threshold. The one or more resources may be associated with sending a physical random access channel (PRACH) preamble. The WTRU may send the PRACH preamble, for example using the one or more selected resources.

The WTRU may determine an active mode of operation for accessing the cell, for example based on the comparison of the determined CLI measurement to the CLI threshold. For example, the WTRU may determine that the active mode of operation comprises a sub-band non-overlapping full duplex (SBFD) operation when the determined CLI measurement is less than the CLI threshold. The WTRU may select the one or more resources from one or more uplink (UL) sub-bands of SBFD symbols and/or one or more slots in a set of allowed resources, for example, when the active mode of operation comprises a SBFD operation. The CLI may be determined by measuring the one or more SSBs from the cell. The determined CLI measurement may include a measurement of CLI received signal strength indicator (RSSI) in a predetermined time period. The WTRU may determine the CLI by measuring one or more reference signals indicated by the configuration information.

The WTRU may monitor for a physical downlink control channel (PDCCH), for example indicating a random access response (RAR) in monitoring occasions in one or more downlink (DL) sub-bands of SBFD symbols and/or one or more slots in a set of allowed resources. The WTRU may determine whether the cell supports a SBFD operation. The configuration information may include an indication to measure CLI associated with the cell.

A WTRU may select a cell and a synchronization signal block (SSB) associated with the cell, for example based on a reference signal received power (RSRP) measurement. The WTRU may receive configuration information. The configuration information may include a physical random access channel (PRACH) cross-link interference (CLI) threshold and/or one or more time and frequency resources. The WTRU may determine CLI (e.g., a CLI measurement), for example using the one or more time and frequency resources. The WTRU may compare the determined CLI measurement with the PRACH CLI threshold. The WTRU may determine an active mode of operation, for example based on the comparison of the determined CLI measurement to the PRACH CLI threshold. The WTRU may determine the active mode to be subband non-overlapping full duplex (SBFD), for example if the determined CLI measurement is less than the PRACH CLI threshold.

The configuration information may include a first indication of one or more first resources for an SBFD active mode and/or a second indication of one or more second resources for a non-SBFD mode. The WTRU may transmit a PRACH message to a base station, for example using the one or more first resources. The PRACH message may include an indication that the WTRU supports SBFD. The WTRU may transmit a preamble (e.g., PRACH preamble) to the base station using the one or more first resources, for example before transmitting the PRACH message. The preamble may include an indication that the WTRU supports SBFD. For example, the preamble may be the indication that the WTRU supports SBFD. The WTRU may transmit the PRACH message to a base station using the one or more second resources. The WTRU may transmit the preamble to the base station using the one or more second resources.

The WTRU may transmit a physical uplink shared channel (PUSCH) message, for example using the one or more second resources. The PUSCH message may include an indication that the WTRU supports SBFD. The WTRU may determine the active mode to be non-SBFD, for example if the determined CLI measurement is greater than or equal to the PRACH CLI threshold. The WTRU may transmit the PRACH message using one or more resources for a non-SBFD mode. The WTRU may determine the one or more resources for the non-SBFD mode, for example based on an indication in the configuration information.

### SUMMARY

A wireless transmit/receive unit (WTRU) may receive a configuration. For example, the WTRU may receive configuration information. The configuration information may indicate (e.g., include) a threshold and/or one or more configured resources. The WTRU may measure a cross-link interference (CLI), for example associated with the one or more configured resources. For example, the WTRU may measure the CLI based on the configuration information. The WTRU may determine that the CLI associated with the one or more configured resources is less than the threshold. The WTRU may determine to use subband non-overlapping full duplex (SBFD) operation. For example, the WTRU may determine to use SBFD operation for accessing a cell. The SBFD operation may include selecting a resource from a subband of an SBFD symbol. The WTRU may compare the (e.g., measured) CLI to the threshold. The WTRU may determine an operation mode. The operation mode may be based on the comparison of the CLI to the threshold. The operation mode may be one or more of subband non-overlapping full duplex (SBFD) or non-SBFD. The WTRU may detect one or more synchronization signal blocks (SSBs). For example, the WTRU may detect one or more synchronization signal blocks (SSBs) from a cell. In another example, the WTRU may detect one or more synchronization signal blocks (SSBs) from a cell during initial access. The WTRU may transmit a physical random access channel (PRACH) preamble. For example, the WTRU may transmit a physical random access channel (PRACH) preamble based on the operation mode. The WTRU may send (e.g., transmit) the PRACH preamble using the selected resource. In some examples, the WTRU may determine that the operation mode is SBFD if the CLI is less than the threshold. In other examples, the WTRU may determine that the operation mode is non-SBFD if the CLI exceeds the threshold.

A WTRU may detect one or more synchronization signal blocks (SSBs) from a cell. The WTRU may receive configuration information. The configuration information may include an indication of a cross-link interference (CLI) threshold. The WTRU may determine a CLI associated with the cell. For example, the WTRU may determine the CLI associated with the cell based on the configuration information. The WTRU may compare the determined CLI (e.g., CLI measurement) to the CLI threshold. The WTRU may select one or more resources, for example, based on the comparison of the determined CLI measurement to the CLI threshold. The one or more resources may be associated with sending a physical random access channel (PRACH) preamble. The WTRU may send the PRACH preamble, for example using the one or more selected resources.

The WTRU may determine an active mode of operation for accessing the cell, for example based on the comparison of the determined CLI measurement to the CLI threshold. For example, the WTRU may determine that the active mode of operation comprises a sub-band non-overlapping full duplex (SBFD) operation when the determined CLI measurement is less than the CLI threshold. The WTRU may select the one or more resources from one or more uplink (UL) sub-bands of SBFD symbols and/or one or more slots in a set of allowed resources, for example, when the active mode of operation comprises a SBFD operation. The CLI may be determined by measuring the one or more SSBs from the cell. The determined CLI measurement may include a measurement of CLI received signal strength indicator (RSSI) in a predetermined time period. The WTRU may determine the CLI by measuring one or more reference signals indicated by the configuration information.

The WTRU may monitor for a physical downlink control channel (PDCCH), for example indicating a random access response (RAR) in monitoring occasions in one or more downlink (DL) sub-bands of SBFD symbols and/or one or more slots in a set of allowed resources. The WTRU may determine whether the cell supports a SBFD operation. The configuration information may include an indication to measure CLI associated with the cell.

A WTRU may select a cell and a synchronization signal block (SSB) associated with the cell, for example based on a reference signal received power (RSRP) measurement. The WTRU may receive configuration information. The configuration information may include a physical random access channel (PRACH) cross-link interference (CLI) threshold and/or one or more time and frequency resources. The WTRU may determine CLI (e.g., a CLI measurement), for example using the one or more time and frequency resources. The WTRU may compare the determined CLI measurement with the PRACH CLI threshold. The WTRU may determine an active mode of operation, for example based on the comparison of the determined CLI measurement to the PRACH CLI threshold. The WTRU may determine the active mode to be subband non-overlapping full duplex (SBFD), for example if the determined CLI measurement is less than the PRACH CLI threshold.

The configuration information may include a first indication of one or more first resources for an SBFD active mode and/or a second indication of one or more second resources for a non-SBFD mode. The WTRU may transmit a PRACH message to a base station, for example using the one or more first resources. The PRACH message may include an indication that the WTRU supports SBFD. The WTRU may transmit a preamble (e.g., PRACH preamble) to the base station using the one or more first resources, for example before transmitting the PRACH message. The preamble may include an indication that the WTRU supports SBFD. For example, the preamble may be the indication that the WTRU supports SBFD. The WTRU may transmit the PRACH message to a base station using the one or more second resources. The WTRU may transmit the preamble to the base station using the one or more second resources.

The WTRU may transmit a physical uplink shared channel (PUSCH) message, for example using the one or more second resources. The PUSCH message may include an indication that the WTRU supports SBFD. The WTRU may determine the active mode to be non-SBFD, for example if the determined CLI measurement is greater than or equal to the PRACH CLI threshold. The WTRU may transmit the PRACH message using one or more resources for a non-SBFD mode. The WTRU may determine the one or more resources for the non-SBFD mode, for example based on an indication in the configuration information.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example procedure for determining resources for a PRACH preamble.

FIG. 3 is a diagram illustrating an example procedure for selecting one or more SSBs.

FIG. 4 is a diagram illustrating an example of subband non-overlapping full duplex (SBFD).

FIG. 5 is a diagram illustrating an example of SBFD operation in synchronization symbol block (SSB) symbols for an SSB burst.

FIG. 6 is a diagram illustrating an example of SBFD operation in downlink (DL) only symbols for an SSB burst.

FIG. 7 is a diagram illustrating an example procedure for determining an active mode of operation.

FIG. 8 is a diagram illustrating an example procedure for determining to start a barring time period.

FIG. 9 is a diagram illustrating an example procedure for determining that a cell is barred from SBFD operation.

### DETAILED DESCRIPTION

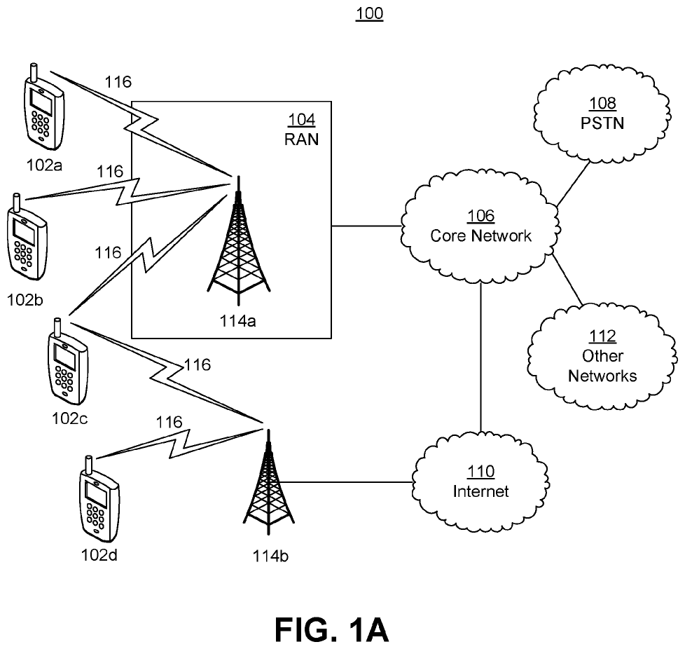

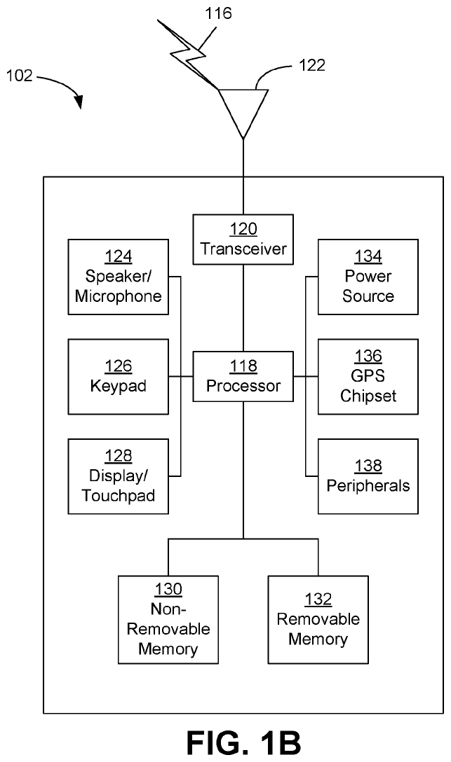

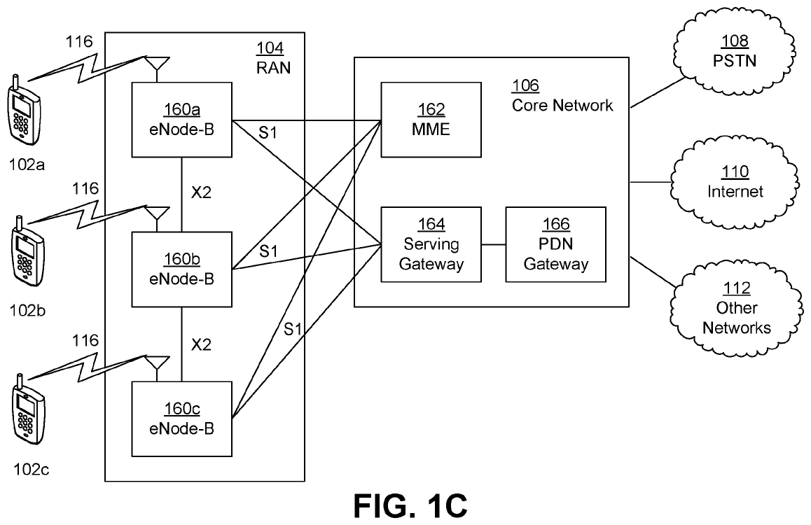

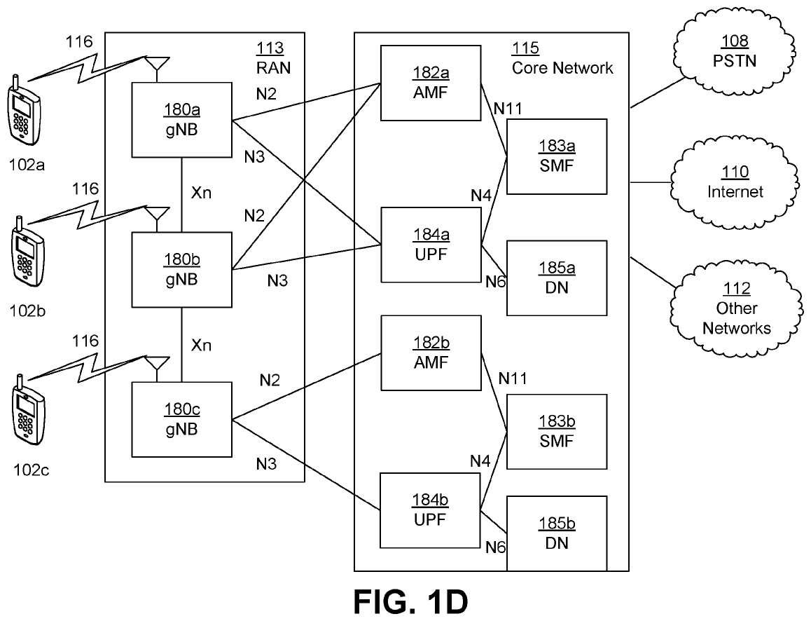

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station and/or a STA, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an ad-hoc mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may receive a configuration. For example, the WTRU may receive configuration information. The configuration information may indicate (e.g., include) a threshold and/or one or more configured resources. The WTRU may measure a cross-link interference (CLI), which for example may be associated with the one or more configured resources. The WTRU may measure the CLI based on the configuration information. The WTRU may determine that the CLI associated with the one or more configured resources is less than the threshold. The WTRU may determine to use subband non-overlapping full duplex (SBFD) operation. For example, the WTRU may determine to use SBFD operation for accessing a cell. The SBFD operation may include selecting a resource from a subband of an SBFD symbol. The WTRU may compare the (e.g., measured) CLI to the threshold. The WTRU may determine an operation mode. The operation mode may be based on the comparison of the CLI to the threshold. The operation mode may be one or more of subband non-overlapping full duplex (SBFD) or non-SBFD. The WTRU may detect one or more synchronization signal blocks (SSBs). For example, the WTRU may detect one or more synchronization signal blocks (SSBs) from a cell. The WTRU may detect one or more synchronization signal blocks (SSBs) from a cell during initial access. The WTRU may transmit a physical random access channel (PRACH) preamble. For example, the WTRU may transmit a physical random access channel (PRACH) preamble based on an operation mode. The operation mode may be an active mode of operation. The WTRU may send (e.g., transmit) the PRACH preamble, for example using the selected resource. The WTRU may determine that the operation mode is SBFD, for example if the CLI is less than the threshold. The WTRU may determine that the operation mode is non-SBFD, for example if the CLI exceeds the threshold.

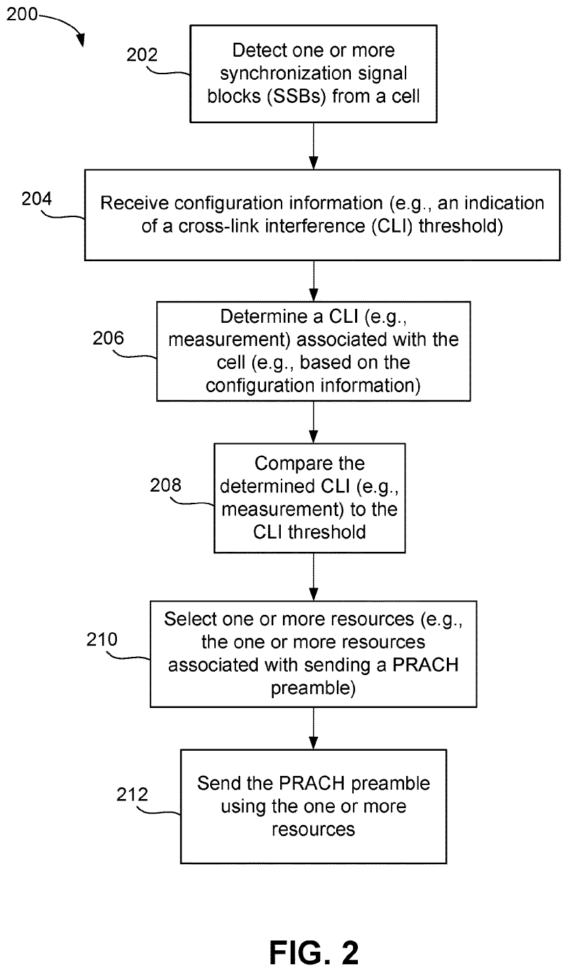

FIG. 2 is a diagram illustrating an example procedure 200 for determining resources for a PRACH preamble. At 202, a WTRU may detect one or more synchronization signal blocks (SSBs). For example, the WTRU may detect one or more synchronization signal blocks (SSBs) from a cell. At 204 the WTRU may receive configuration information. The configuration information may indicate (e.g., include) a threshold. For example, the configuration information may include an indication of a cross-link interference (CLI) threshold. The WTRU may measure a cross-link interference (CLI). Additionally, or alternatively, the configuration information may include an indication to measure CLI associated with the cell. At 206 the WTRU may determine a CLI associated with the cell. For example, the WTRU may measure a CLI for the one or more SSBs. The WTRU may determine (e.g., measure) a CLI (e.g., CLI measurement) for the one or more SSBs based on the configuration. The CLI (e.g., CLI measurement) may be determined by measuring the one or more SSBs from the cell. The determined CLI may include a measurement of CLI received signal strength indicator (RSSI) in a predetermined time period. The WTRU may determine the CLI by measuring one or more reference signals indicated by the configuration information.

The WTRU may select the one or more SSBs. For example, the WTRU may select the one or more SSBs based on the measured CLI. At 208 the WTRU may compare the determined CLI measurement to the CLI threshold. The WTRU may compare the (e.g., measured) CLI to the one or more selected SSBs to the threshold. The WTRU may rank the one or more SSBs. For example, the WTRU may rank the one or more SSBs based on a comparison of the CLI to the threshold. The WTRU may determine an operation mode. The operation mode may be based on the comparison of the CLI to the threshold. The WTRU may determine an active mode of operation for accessing the cell, for example based on the comparison of the determined CLI measurement to the CLI threshold. The operation mode may be one or more of subband non-overlapping full duplex (SBFD) or non-SBFD. The WTRU may detect the one or more SSBs (e.g., from a cell) during initial access. For example, the WTRU may determine that the active mode of operation comprises a sub-band non-overlapping full duplex (SBFD) operation when the determined CLI measurement is less than the CLI threshold.

At 210 the WTRU may select one or more resources. The WTRU may select the one or more resources from one or more uplink (UL) sub-bands of SBFD symbols and/or one or more slots in a set of allowed resources, for example when the active mode of operation comprises a SBFD operation. The one or more resources may be associated with sending a physical random access channel (PRACH) preamble. At 212 the WTRU may send the PRACH preamble, for example using the one or more selected resources. For example, the WTRU may transmit a physical random access channel (PRACH) preamble based on the ranking. In some examples, the WTRU may determine that the operation mode is SBFD if the CLI is less than the threshold. In other examples, the WTRU may determine that the operation mode is non-SBFD if the CLI exceeds the threshold.

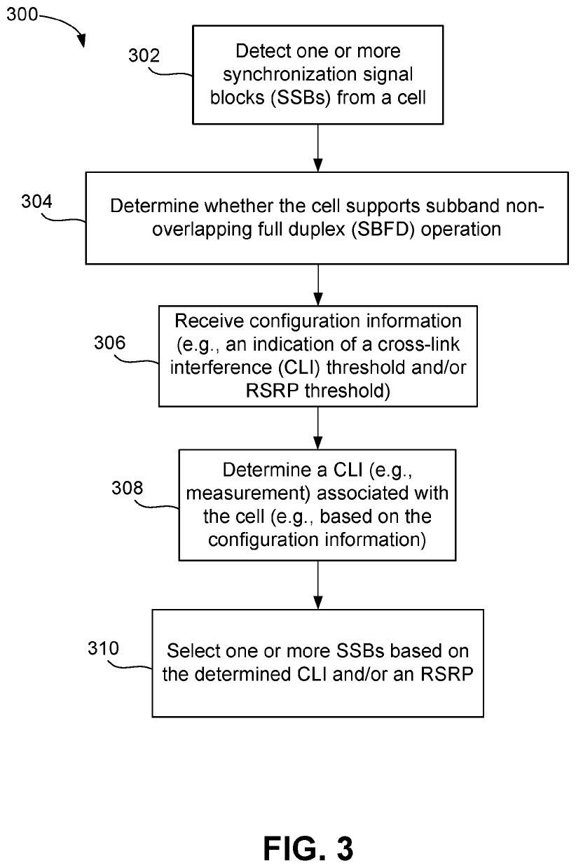

FIG. 3 is a diagram illustrating an example procedure 300 for selecting one or more SSBs. A WTRU may select a cell. At 302 a WTRU may detect one or more synchronization signal blocks (SSBs), for example from one or more cells. For example, a WTRU may select a cell and an associated synchronization signal block (SSB), for example associated with the cell. At 304 the WTRU may determine whether the one or more cells support subband non-overlapping full duplex (SBFD) operation.

At 306 the WTRU may receive configuration information. The configuration information may include an indication of a threshold and/or an indication to measure cross-link interference (CLI) associated with the one or more cells. Additionally, or alternatively, the threshold may be associated with one or more of CLI and/or a reference signal received power (RSRP). The configuration may indicate (e.g., include) a physical random access channel (PRACH) cross-link interference (CLI) threshold and/or one or more resources.

At 308 the WTRU may determine a CLI (e.g., a CLI measurement) associated with each of the one or more cells, for example based on the configuration information. The WTRU may measure the CLI, for example associated with the one or more resources. The WTRU may compare the (e.g., measured) CLI to the PRACH CLI threshold. At 310 the WTRU may select one or more SSBs, for example based on one or more of the determined CLI measurement and/or RSRP. The WTRU may select the one or more SSBs based on the determined CLI measurement and the RSRP, for example to select the one or more SSBs based on one or more of the determined CLI measurement and/or the RSRP. The WTRU may select the one or more SSBs based on one or more of the SSBs having at least one of the lowest determined CLI measurement or a highest RSRP, for example to select the one or more SSBs based on one or more of the determined CLI measurement and/or the RSRP.

The WTRU may compare the threshold to the determined CLI measurement and/or determine whether to include a cell associated with the one or more SSBs in a list of candidate cells based on the comparison, for example when the threshold is associated with CLI. The WTRU may determine to include the cell associated with the one or more SSBs in the list of candidate cells, for example if the determined CLI measurement is less than the threshold. The WTRU may determine not to include the cell associated with the one or more SSBs in the list of candidate cells, for example if the determined CLI measurement is greater than or equal to the threshold.

The WTRU may rank the one or more cells based on at least one of the determined CLI measurement and/or the determined RSRP. The WTRU may select the cell with the highest ranking. The WTRU may determine a mode of operation to be SBFD, for example if the cell with the highest ranking supports SBFD. The WTRU may determine a mode of operation to be non-SBFD, for example if the cell with the highest ranking does not support SBFD. The WTRU may send a physical random access channel (PRACH) transmission, for example to the cell with the highest ranking.

The WTRU may determine a random access (RA) type. For example, the WTRU may determine an RA type based on the comparison of the CLI to the PRACH CLI threshold. The WTRU may transmit a preamble to the selected cell, for example based on the determined RA type. The preamble may be a physical random access channel (PRACH) preamble. The WTRU may determine that the RA type is 2-step. For example, the WTRU may determine that the RA type is 2-step if the CLI is less than the threshold. The WTRU may determine that the RA type is 4-step. For example, the WTRU may determine that the RA type is 4-step if the CLI exceeds the threshold. Additionally, or alternatively, the WTRU may determine that the RA type is 2-step if a reference signal received power (RSRP) exceeds an RSRP threshold. Additionally, or alternatively, the WTRU may determine that the RA type is 4-step by determining that a reference signal received power (RSRP) is less than an RSRP threshold. The WTRU may determine an operation mode. The operation mode may be based on the comparison of the CLI to the PRACH CLI threshold. The operation mode may be one or more of subband non-overlapping full duplex (SBFD) or non-SBFD.

A WTRU may select a cell. The WTRU may transmit a physical random access channel (PRACH), for example using one or more resources. The WTRU may transmit a PRACH preamble. For example, the WTRU may transmit a PRACH (e.g., preamble) to the cell. The WTRU may detect a downlink control information (DCI). The DCI may be associated with a random access response (RAR), for example from the cell. The WTRU may receive the RAR. The RAR may indicate (e.g., include) an operation mode. The operation mode may be one or more of subband non-overlapping full duplex (SBFD) or non-SBFD. The WTRU may receive the RAR within a RAR time window. The RAR may indicate (e.g., include) that that the operation mode is SBFD. The WTRU may transmit a connection message to the cell, for example if the RAR indicates that the operation mode is SBFD. The RAR may indicate (e.g., include) that that the operation mode is non-SBFD. The WTRU may transmit a connection message to the cell, for example if the RAR indicates that the operation mode is non-SBFD. Additionally, or alternatively, the WTRU may add the cell to a list of cells barred from SBFD. For example, if the RAR indicates that the operation mode is non-SBFD, the WTRU may add the cell to a list of cells barred from SBFD operation. The WTRU may transmit a preamble (e.g., a PRACH preamble) to a second cell. For example, if the RAR indicates that the operation mode is non-SBFD, the WTRU may transmit a preamble (e.g., a PRACH preamble) to a second cell.

A WTRU may receive a subband non-overlapping full duplex (SBFD) barring time period. The WTRU may receive a cross link interference (CLI) threshold. The CLI threshold may be associated with the SBFD barring time period. The WTRU may transmit a SBFD message. For example, the WTRU may transmit a SBFD message to a cell. The WTRU may receive a response message, for example from the cell. The response message may be based on and/or in response to the SBFD message. Additionally, or alternatively, the response message may indicate that the cell is barred from SBFD operation. The WTRU may perform cell ranking. For example, the WTRU may perform cell ranking based on the SBFD barring time period and/or a CLI measurement. The WTRU may determine to select the cell or a second cell. For example, the WTRU may determine to select the cell and/or a second cell based on the cell ranking. The WTRU may measure a cross-link interference (CLI). Additionally, or alternatively, the WTRU may compare the CLI to a threshold (e.g., CLI threshold). The WTRU may determine that the cell is an SBFD candidate. For example, the WTRU may determine that the cell is an SBFD candidate if the CLI is less than the threshold (e.g., CLI threshold). The WTRU may measure the CLI when there is (e.g., triggered by) an expiry of the SBFD barring time period. The WTRU may transmit a physical random access channel (PRACH) (e.g., preamble) message. For example, the WTRU may transmit the PRACH (e.g., preamble) message to the (e.g., first) cell and/or the second cell. Additionally, or alternatively, the WTRU may transmit the PRACH (e.g., preamble) to the first cell and/or the second cell based on the cell ranking. Additionally, or alternatively, the WTRU may send (e.g., transmit) the PRACH (e.g., preamble) message according to SBFD operation.

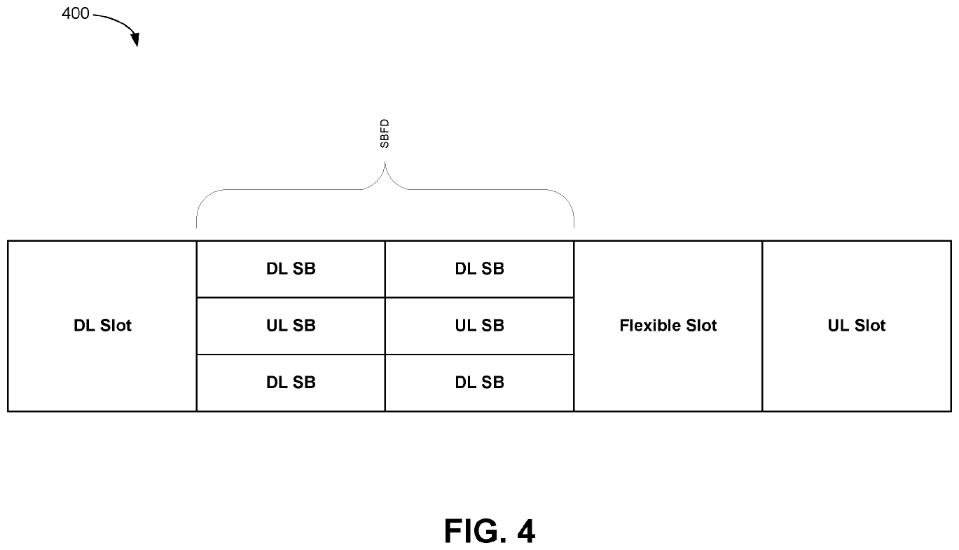

Duplex operation may improve conventional time-division duplexing (TDD) operation, for example by one or more of enhancing uplink (UL) coverage, improving capacity, reducing latency, etc. TDD may be based on splitting the time domain between the uplink and the downlink. Full duplex and/or subband non-overlapping full duplex (SBFD) may be implemented at the gNB, for example within a conventional TDD band. FIG. 4 depicts an example SBFD operation 400.

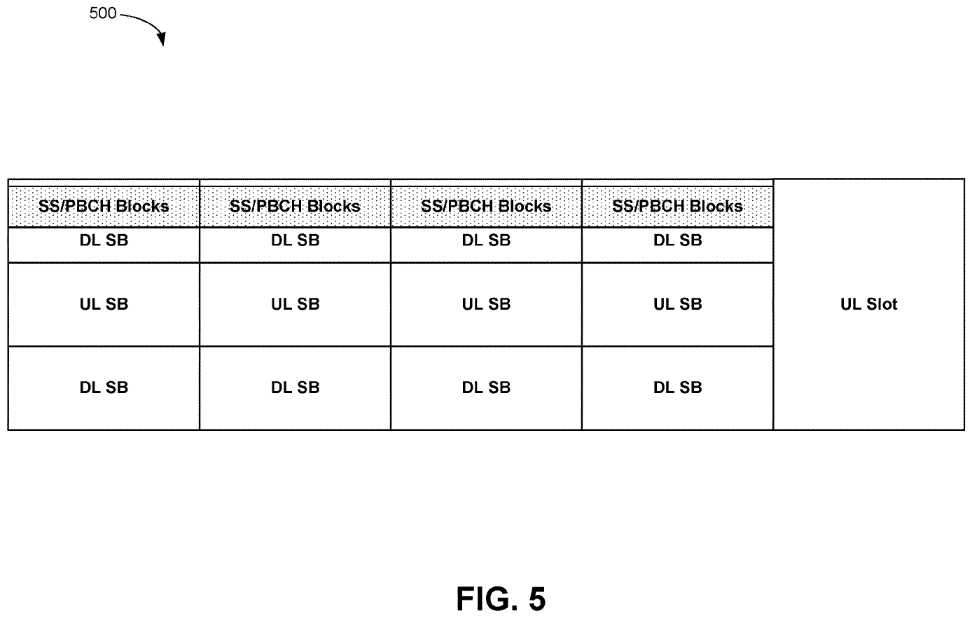

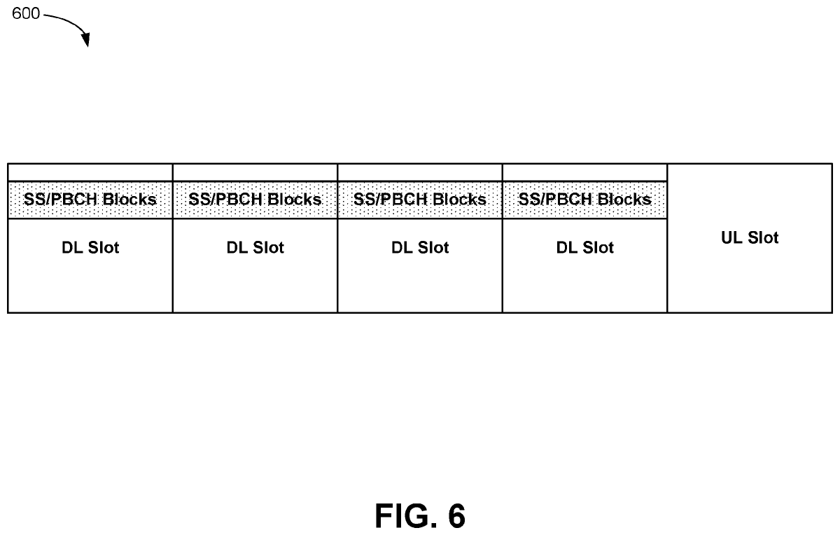

In TDD, the transmission of synchronization signal (SS)/physical broadcast channel (PBCH) blocks (SSB) may be possible in downlink (DL) (e.g., DL-only) symbols. A wireless transmit/receive unit (WTRU) may not expect to be scheduled for an uplink (UL) in SSB symbols. In subband non-overlapping full duplex (SBFD) operation for example, if SSB symbols are not used from SBFD operation, this may affect and/or degrade the SBFD performance. FIG. 5 depicts an example SBFD operation 500 in SSB symbols for an SSB burst. FIG. 6 depicts an example SBFD operation 600 in DL-only symbols for an SSB burst.

During cell (re)selection for example, a WTRU may to go through one or more (e.g., all) initial access procedures (e.g., 4 or 2 steps physical random access channel (PRACH)). A WTRU may measure cross link interference (CLI) and/or determine that a connection is not possible, for example due to (e.g., based on) CLI. For example, the WTRU may measure cross link interference (CLI) and/or determine that a connection is not possible due to CLI after switching to radio resource control (RRC) connected-mode. Additionally, or alternatively, the WTRU may go through a cell reselection and/or a hand-over procedure that, for example may increase the latency and/or cause a ping-pong affect.

A WTRU may transmit and/or receive a physical channel and/or reference signal. For example, the WTRU may transmit and/or receive a physical channel and/or reference signal according to at least one spatial domain filter. The term beam may be used herein to refer to a spatial domain filter. The WTRU may transmit a physical channel and/or signal, for example using the same spatial domain filter as the spatial domain filter used for receiving a reference signal (RS) (e.g., channel state information-reference signal (CSI-RS)) and/or a SS block. The WTRU transmission may be referred to as target herein. The received RS and/or SS block may be referred to as reference and/or source. The WTRU may transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel or signal. The first and second transmissions may be referred to as target, and reference and/or source, respectively. The WTRU may transmit the first (e.g., target) physical channel or signal according to a spatial relation with a reference to the second (e.g., reference) physical channel or signal.

A spatial relation may be implicit, configured by RRC and/or signaled by MAC CE and/or DCI. For example, a WTRU may implicitly transmit PUSCH and/or DM-RS of PUSCH according to the same spatial domain filter as an SRS indicated by an SRI indicated in DCI and/or configured by RRC. A spatial relation may be configured by RRC for an SRS resource indicator (SRI) and/or signaled by medium access control (MAC) control element (CE) for a physical uplink control channel (PUCCH). A spatial relation may also be referred to as a beam indication herein.

The WTRU may receive a first (e.g., target) downlink channel and/or signal according to the same spatial domain filter and/or spatial reception parameter as a second (e.g., reference) downlink channel and/or signal. The WTRU may monitor for a physical downlink control channel (PDCCH), for example indicating a random access response (RAR) in monitoring occasions in one or more downlink (DL) sub-bands of SBFD symbols and/or one or more slots in a set of allowed resources. The WTRU may determine whether the cell supports a SBFD operation.

An association may exist between a physical channel (e.g., PDCCH and/or PDSCH) and a respective demodulation reference signal (DM-RS). For example, an association may exist when the WTRU is configured with a quasi-colocation (QCL) assumption type D between corresponding antenna ports. Additionally, or alternatively, an association may exist when the WTRU is configured with a quasi-colocation (QCL) assumption type D between corresponding antenna ports at least when the first and/or second signals are reference signals. An association may be configured as a transmission configuration indicator (TCI) state. A WTRU may be indicated in an association between a CSI-RS or SS block and a DM-RS, for example by an index to a set of TCI states configured by RRC and/or signaled by MAC CE. The indication may also be referred to as a beam indication herein.

As herein, a transmission and reception point (TRP) may be interchangeably used with one or more of transmission point (TP), reception point (RP), radio remote head (RRH), distributed antenna (DA), base station (BS), a sector (e.g., of a BS), and/or a cell (e.g., a geographical cell area served by a BS). Herein, multi-transmission reception point (Multi-TRP) may be interchangeably used with one or more of MTRP, M-TRP, and/or multiple TRPs.

Herein, the term subband and/or sub-band may be used to refer to a frequency-domain resource and/or may be characterized by at least one of a set of resource blocks (RBs); a set of resource block sets (RB sets); when a carrier has intra-cell guard bands; a set of interlaced resource blocks; a bandwidth part or a portion thereof; a carrier or a portion thereof. A subband may be characterized by a starting RB and/or a number of RBs, for example for a set of contiguous RBs within a bandwidth part. A subband may additionally, or alternatively, comprise a value of a frequency-domain resource allocation field and/or bandwidth part index.

Herein, the term XDD may be used to refer to a subband-wise duplex (e.g., either UL and/or DL being used per subband) and/or may be characterized by at least one of cross division duplex (e.g., subband-wise frequency division duplexing (FDD) within a TDD band); subband non-overlapping full duplex (SBFD); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a subband non-overlapping full duplex (e.g., non-overlapped sub-band full-duplex); a full duplex other than a same-frequency (e.g., spectrum sharing and/or subband-wise-overlapped) full duplex; and/or an advanced duplex method (e.g., other than (pure) TDD or FDD).

Herein, the term dynamic (e.g., and/or flexible) TDD may refer to a TDD system/cell. The TCC system/cell may dynamically and/or flexibly change/adjust/switch a communication direction (e.g., a downlink, an uplink, a sidelink, and/or etc.) on a time instance (e.g., slot, symbol, subframe, and/or the like). A component carrier (CC) or a bandwidth part (BWP) may include a (e.g., one single) type among ‘D’, ‘U’, and ‘F’ on a symbol/slot, for example in a system employing dynamic/flexible TDD. The type may be based on an indication by a group-common (GC)-DCI (e.g., format 2_0). The GC-DCI may include a slot format indicator (SFI), and/or be based on tdd-UL-DL-config-common/dedicated configurations. A first gNB (e.g., cell and/or TRP), for example employing dynamic/flexible TDD, may transmit a downlink signal to a first WTRU. The first gNB (e.g., cell, TRP) employing dynamic/flexible TDD may transmit a downlink signal to a first WTRU on a given time instance/slot/symbol. The WTRU may be in communication with/associated with the first gNB based on a first SFI and/or tdd-UL-DL-config. The SFI and/or tdd-UL-DL-config may be configured/indicated by the first gNB, and/or a second gNB (e.g., cell, TRP), for example employing dynamic/flexible TDD. The first gNB and/or the second gNB may receive an uplink signal transmitted from a second WTRU being communicated/associated with the second gNB based on a second SFI and/or tdd-UL-DL-config configured/indicated by the second gNB. The first WTRU may determine that the uplink signal is interfering with the reception of the downlink signal. The interference caused by the uplink signal may refer to a WTRU-to-WTRU cross-layer interference (CLI).

A WTRU may report a subset of channel state information (CSI) components. The CSI components may correspond to one or more of a CSI-RS resource indicator (CRI), a SSB resource indicator (SSBRI), an indication of a panel used for reception at the WTRU (e.g., a panel identity or group identity), measurements (e.g., L1-RSRP, L1-SINR) taken from SSB and/or CSI-RS (e.g. cri-RSRP, cri-SINR, ssb-Index-RSRP, ssb-Index-SINR), and/or other channel state information (e.g., one or more of rank indicator (RI), channel quality indicator (CQI), precoding matrix indicator (PMI), Layer Index (LI), and/or the like).

A WTRU may receive a synchronization signal/physical broadcast channel (SS/PBCH) block. The SS/PBCH block (SSB) may include one or more of a primary synchronization signal (PSS), secondary synchronization signal (SSS), and physical broadcast channel (PBCH). The WTRU may monitor, receive, and/or attempt to decode an SSB, for example during one or more of initial access, initial synchronization, radio link monitoring (RLM), cell search, cell switching, and/or etc. A WTRU may measure and/or report the channel state information (CSI). The CSI for each connection mode may include or be configured with one or more of CSI report configuration; CSI-RS resource set; and/or non-zero power (NZP) CSI-RS resources. A CSI report configuration may include one or more of CSI report quantity (e.g., channel quality indicator (CQI), rank indicator (RI), precoding matrix indicator (PMI), CSI-RS resource indicator (CRI), layer indicator (LI), etc.), CSI report type (e.g., aperiodic, semi persistent, periodic), CSI report codebook configuration (e.g., Type I, Type II, Type II port selection, etc.), and/or CSI report frequency. A CSI-RS resource set may include one or more CSI resource settings. CSI resource settings may include one or more of NZP-CSI-RS resource for channel measurement; NZP-CSI-RS resource for interference measurement; and/or CSI-IM resource for interference measurement. NZP CSI-RS resources may include one or more of NZP CSI-RS resource ID; periodicity and offset; QCL info and TCI-state; and/or resource mapping (e.g., number of ports, density, CDM type, etc.)

A WTRU may indicate, determine, and/or be configured with one or more reference signals. The WTRU may monitor, receive, and/or measure one or more parameters, for example based on the respective reference signals. The following parameters are non-limiting examples of the parameters that may be included in reference signal(s) measurements. One or more of these parameters may be included. Other parameters may be included. For example, parameters may include one or more of SS reference signal received power (SS-RSRP); CSI-RSRP; SS signal-to-noise and interference ratio (SS-SINR); CSI-SINR; received signal strength indicator (RSSI); cross-layer interference received signal strength indicator (CLI-RSSI); sounding reverence signals RSRP (SRS-RSRP); secondary synchronization signal reference signal received quality (SS-RSRQ); and/or CSI reference signal received quality (CSI-RSRQ).

SS reference signal received power (SS-RSRP) may be measured, for example based on the synchronization signals (e.g., demodulation reference signal (DMRS) in PBCH and/or SSS). SS-RSRP may include a linear average over the power contribution of the resource elements (RE) that carry the respective synchronization signal. In measuring the RSRP for example, power scaling for the reference signals may be utilized. The measurement may be made based on CSI reference signals in addition to, or in the alternative to, the synchronization signals, for example if SS-RSRP is used for L1-RSRP.

CSI-RSRP may be measured, for example based on the linear average over the power contribution of the resource elements (RE) that carry the respective CSI-RS. The CSI-RSRP measurement may be configured within measurement resources for the configured CSI-RS occasions.

SS signal-to-noise and interference ratio (SS-SINR) may be measured based on the synchronization signals (e.g., DMRS in PBCH and/or SSS). SS-SINR may include the linear average over the power contribution of the resource elements (RE) that carry the respective synchronization signal divided by the linear average of the noise and interference power contribution. The noise and/or interference power measurement may be made based on resources configured by higher layers, for example if SS-SINR is used for L1-SINR.

CSI-SINR may be measured based on the linear average over the power contribution of the resource elements (RE) that carry the respective CSI-RS divided by the linear average of the noise and interference power contribution. The noise and/or interference power measurement may be made based on resources configured by higher layers, for example if CSI-SINR is used for L1-SINR. In some examples (e.g., otherwise), the noise and interference power may be measured based on the resources that carry the respective CSI-RS.

Received signal strength indicator (RSSI) may be measured, for example based on the average of the total power contribution in configured OFDM symbols and/or bandwidth. The power contribution may be received from different resources. For example, the power contribution may be received from one or more of co-channel serving and non-serving cells, adjacent channel interference, thermal noise, and/or etc.

Cross-Layer interference received signal strength indicator (CLI-RSSI) may be measured, for example based on the average of the total power contribution in configured OFDM symbols of the configured time and/or frequency resources. The power contribution may be received from different resources. For example, the power contribution may be received from one or more of cross-layer interference, co-channel serving and non-serving cells, adjacent channel interference, thermal noise, and/or etc.

Sounding reference signals RSRP (SRS-RSRP) may be measured based on the linear average over the power contribution of the resource elements (RE) that carry the respective SRS.

Secondary synchronization signal reference signal received quality (SS-RSRQ) may be measured, for example based on measurements on the reference signal received power (SS-RSRP) and/or received signal strength (RSSI). The SS-RSRQ may be calculated as a ratio of N×SS-RSRP and NR carrier RSSI. N may be determined based on the number of resource blocks that are in the corresponding NR carrier RSSI measurement bandwidth. Additionally, or alternatively, the measurements to be used in the numerator and/or denominator may be over the same set of resource blocks.

CSI reference signal received quality (CSI-RSRQ) may be measured, for example based on measurements on the reference signal received power (CSI-RSRP) and/or received signal strength (RSSI). The SS-RSRQ may be calculated as the ratio of N×CSI-RSRP and CSIRSSI. N may be determined based on the number of resource blocks that are in the corresponding CSI-RSSI measurement bandwidth. Additionally, or alternatively, the measurements to be used in the numerator and denominator may be over the same set of resource blocks.

A property of a grant and/or assignment may include one or more of a frequency allocation; an aspect of time allocation (e.g., a duration); a priority; a modulation and coding scheme; a transport block size; a number of spatial layers; a number of transport blocks; TCI state, CRI and/or SRI; a number of repetitions; whether the repetition scheme is Type A or Type B; whether the grant is a configured grant type 1, type 2 or a dynamic grant; whether the assignment is a dynamic assignment or a semi-persistent scheduling (e.g., configured) assignment; a configured grant index or a semi-persistent assignment index; a periodicity of a configured grant or assignment; a channel access priority class (CAPC); and/or any parameter provided in a DCI, by MAC and/or by RRC for the scheduling the grant or assignment.

An indication by DCI may include one or more of an explicit indication by a DCI field and/or by RNTI used to mask or scramble the CRC of the DCI; an implicit indication by a property including, but not limited to one or more of DCI format, DCI size, coreset or search space, aggregation level, first resource element of the received DCI (e.g., index of first control channel element). Mapping between the property and the value may be signaled by RRC and/or MAC. Receiving and/or monitoring for a DCI with and/or using an RNTI may additionally, or alternatively mean that the CRC of the DCI is masked and/or scrambled with the RNTI.

Herein, a signal may be interchangeably used with one or more a sounding reference signal (SRS); channel state information-reference signal (CSI-RS); demodulation reference signal (DM-RS); phase tracking reference signal (PT-RS); and/or synchronization signal block (SSB).

Herein, a channel may be interchangeably used with one or more of physical downlink control channel (PDCCH); physical downlink shared channel (PDSCH); physical uplink control channel (PUCCH); physical uplink shared channel (PUSCH); physical random access channel (PRACH); and/or etc.

Herein, downlink reception may be used interchangeably with Rx occasion, PDCCH, PDSCH, and/or SSB reception. Herein, uplink transmission may be used interchangeably with Tx occasion, PUCCH, PUSCH, PRACH, and/or SRS transmission. Herein, RS may be interchangeably used with one or more of RS resource, RS resource set, RS port, and/or RS port group. Herein, RS may be interchangeably used with one or more of SSB, CSI-RS, SRS, and/or DM-RS. Herein, time instance, slot, symbol, and subframe may be used interchangeably. Herein, UL-only and/or DL-only Tx/Rx occasions may interchangeably be used with legacy TDD UL or legacy TDD DL, respectively. Legacy TDD UL/DL Tx/Rx occasions may include cases where SBFD is not configured and/or where SBFD is disabled. Herein, the term energy per resource element (EPRE) may be used interchangeably with one or more of received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, CSI-RSRQ, and/or etc.

Cell (re)selection for cells operating with SBFD and/or non-SBFD modes of operation is considered, where for example the cells with SBFD operation may be prioritized over cells with non-SBFD operation. Systems and methods disclosed herein may be used for cell (re) selection, for example with prioritization of one or more other mode of operation. The one or more other mode of operation may include one or more of a first mode of operation over cells operating with a second mode of operation, cells operating with a third mode of operation, and/or etc. The terms SBFD operation and non-SBFD operation may be used interchangeably with the first mode of operation and a second mode of operation, respectively, herein.

Herein, the term CLI may be used interchangeably with interference. Herein, the terms SSB, SS/PBCH block, PSS, SSS, PBCH, and/or MIB may be used interchangeably. Herein, the term non-SBFD may be used interchangeably with operation without SBFD, TDD, and/or legacy TDD. Systems and methods disclosed herein may be regarding a potential victim WTRU. Systems and methods disclosed herein may be for one or more of a potential aggressive WTRU, an SBFD-aware WTRU, and/or an SBFD-capable WTRU.

A WTRU may be configured with one or more types of slots within a bandwidth. A first type of slot may be used and/or determined for a first direction (e.g., downlink). A second type of slot may be used and/or determined for a second direction (e.g., uplink). A third type of slot may have a first group of frequency resources within the bandwidth for a first direction and/or a second group of frequency resources within the bandwidth for a second direction. Herein, bandwidth may be interchangeably used with one or more of bandwidth part (BWP), carrier, subband, and/or system bandwidth. The first type of slot (e.g., the slot for a first direction) may be referred to as downlink slot. The second type of slot (e.g., slot for a second direction) may be referred to as uplink slot. The third type of slot may be referred to as sub-band (non-overlapping) full duplex (SBFD) slot. The group of frequency resource for a first direction may be referred to as one or more of downlink subband, downlink frequency resource, and/or downlink RBs. The group of frequency resource for a second direction may be referred to as uplink subband, uplink frequency resource, and/or uplink RBs.

In an example, a (SBFD-enabled) WTRU may receive and/or be configured with one or more SBFD UL and/or DL subbands in one or more DL/UL/flexible TDD time instances (e.g., symbols, slots, frames, and/or etc.). The WTRU may be configured with one or more resource allocations for SBFD subbands. For example, the SBFD configuration may include a flag signal (e.g., enabled/disabled). A first value (e.g., zero (0) may indicate a first mode of operation (e.g., SBFD configuration), and/or a second value (e.g., one (1)) may indicate a second mode of operation (e.g., non-SBFD operation). The modes of operation (e.g., SBFD vs. non-SBFD) may be indicated via one or more of MIB, SIB, semi-statically (e.g., via RRC), dynamic (e.g., via MAC-CE, DCI), and/or etc. The WTRU may receive the time resources (e.g., one or more symbols, slots, and so forth), for which the first mode of operation (e.g., SBFD) may be defined in for example one or more BWPs, subbands, component carriers (CC), cells, and/or etc. The WTRU may receive the frequency resources (e.g., subbands/BWPs including one or more PRBs) within a (e.g., active and/or linked) BWP, for which, for example the first mode of operation (e.g., SBFD) may be configured. The time instances (e.g., slots, symbols) may be indicated based on one or more of periodic, semi-persistent, and/or aperiodic configurations. Time instances may be indicated via a bitmap configuration.

In an example, a WTRU may be configured with a DL TDD configuration for a component carrier (CC) and/or a BWP for one or more Rx occasions (e.g., via tdd-UL-DL-config-common/dedicated configurations, slot format indicator (SFI), and/or etc.). One or more of the configured frequency resources (e.g., subbands, PRBs, and/or BWPs) may be configured for the transmission in UL channels and/or Tx occasions, for example if the first mode of operation (e.g., SBFD) is configured. In another example, the WTRU may be configured with an UL TDD configuration for a component carrier (CC) and/or a BWP for one or more Tx occasions (e.g., via tdd-UL-DL-config-common/dedicated configurations, slot format indicator (SFI), and so forth). One or more of the configured frequency resources (e.g., subbands, PRBs, and/or BWPs) may be configured as the DL channels and/or Rx occasions, for example if the first mode of operation (e.g., SBFD) is configured.

In another example, the WTRU may be configured with a DL, UL, and/or Flexible TDD configuration for a component carrier (CC) and/or a BWP for one or more Rx/Tx occasions (e.g., via tdd-UL-DL-config-common/dedicated configurations, slot format indicator (SFI), and/or etc.). One or more of the configured frequency resources (e.g., subbands, PRBs, and/or BWPs) may be configured for the first mode of operation (e.g., either UL transmission or DL reception based on the configurations), for example if the first mode of operation (e.g., SBFD) is configured. The duplexing mode for the first mode of operation (e.g., SBFD configuration (UL/DL)) may be indicated via a flag indication. A first value (e.g., zero (0) may indicate a first mode (e.g., UL duplexing mode), and/or a second the value (e.g., one (1)) may indicate a second mode (e.g., DL duplexing model). The duplexing mode configuration and/or flag for the first mode of operation (e.g., SBFD) may be configured as part of modes of operation configuration that, for example may be semi-static (e.g., via RRC) or dynamic (e.g., via DCI, MAC-CE). The duplexing mode configuration and/or flag for the first mode of operation (e.g., SBFD) may be configured as part of resource allocation configuration for a Tx/Rx occasion.

A WTRU may be configured, determined, and/or indicated to perform a measurement of cross-link interference (CLI) Received Signal Strength Indicator (RSSI) in a given time period. The given time period may include one or more slots, OFDM symbols, resource blocks (RBs), and/or resource elements (REs). The CLI-RSSI, which for example may be measured in a given time/frequency resource, may be referred to as L1-CLI-RSSI, short-term CLI-RSSI, aperiodic CLI-RSSI, and/or etc. Herein, CLI-RSSI, L1-CLI-RSSI, and/or RSSI may be interchangeably.

One or more RSSI types may be used. Additionally, or alternatively, a WTRU may be configured to perform one or more RSSI types. A first RSSI type may be based on a measurement over a long time period (e.g., more than one slot) and/or the measurement may be reported via a higher layer signaling (e.g., RRC, MAC). A second RSSI type may be based on a measurement over a short time period (e.g., one slot, within a slot, one or more OFDM symbols within a slot) and/or the measurement may be reported via a L1 signaling (e.g., PUCCH, PUSCH, RACH, SRS). RSSI may be interchangeably used with RSRP, RSRQ, and/or SINR.

The WTRU may be configured with a set of time/frequency resources, for example to measure L1-CLI-RSSI. The time/frequency resource for L1-CLI-RSSI measurement may be referred to as CLI-RSSI Measurement Resource (CRMR). CRMR may be a resource configured, determined, and/or defined with one or more of a set of muted REs in downlink resource (e.g., PDSCH); a set of REs not scheduled or used for the WTRU measuring CRMR; a set of REs may be located in an RB which may be configured or determined as guard band (or guard RB); one or more reference signals (e.g., DMRS, SRS, sidelink CSI-RS, etc.); a second set of DMRS REs within a second CDM group (e.g., within a scheduled downlink resource/RBs, e.g., of PDSCH), and/or located within a scheduled resource (e.g., scheduled PDSCH RBs). The muted REs may be rate-matched around and/or punctured for downlink reception and/or uplink transmission. The set of muted REs may have the same pattern (e.g., same time/frequency location) in each RB. The set of muted REs may have a different pattern based on the RB location. For example, a first pattern may be used for the RBs located in an edge of the scheduled RBs and a second pattern may be used for the RBs located in a center of the scheduled RBs. The first pattern and the second pattern may have a different number of muted REs. The muted REs may be in a form of zero-power resources, for example CSI-RS and/or ZP-CSI-RS. A guard band and/or guard RB may be located in between uplink and downlink resources. A WTRU may skip receiving and/or transmitting a signal in guard band. A WTRU may receive a DCI, that may schedule the PDSCH for example. The DCI may additionally, or alternatively, indicate a first set of DMRS REs, for example corresponding to a first CDM group to be used for receiving the PDSCH. The DCI may schedule the PDSCH. The DCI and/or the WTRU may indicate a first set of DMRS REs corresponding to a first CDM group, for example based on an indicated (e.g., DMRS) antenna port field of the DCI. The WTRU may determine that a second set of DMRS REs within a second CDM group (other than the first CDM group) may be used as the CRMR (e.g., within the scheduled PDSCH), for example in response to receiving the DCI for example. CRMR may be configured (e.g., commonly) for a set of WTRUs (e.g., WTRUs in proximity). For example, a gNB may configure a CRMR for a group of WTRUs. The group of WTRUs may share one or more of a group-ID to receive a DCI (e.g., a group-RNTI); a zone-ID; and/or WTRUs paired for sidelink unicast (or groupcast) transmission. The zone-ID may be determined based on a geographical location of the WTRU (e.g., GNSS). An L1-CLI-RSSI measurement (e.g., including CRMR resource) may be considered as a CSI reporting quantity and/or configured as a part of CSI reporting setting.

The WTRU may be configured, determined, and/or indicated to perform a delta CLI-RSSI. The delta CLI-RSSI may be based on a first CLI-RSSI measurement in a first time/frequency location and/or a second CLI-RSSI measurement in a second time/frequency location. The delta CLI-RSSI (delta-CLI-RSSI) may be a difference between a first CLI-RSSI (e.g., CLI-RSSI₁) and a second CLI-RSSI (e.g., CLI-RSSI₂). For example, delta-CLI-RSSI=CLI-RSSI₁−CL-RSSI₂ (or delta-CLI-RSSI=CLI-RSSI₂−CL-RSSI₁, etc.). The first CLI-RSSI may be measured from CRMR resources located in the edge of the scheduled RBs. The second CLI-RSSI may be measured from CRMR resources located in the middle of the scheduled RBs. A WTRU may be configured with a first CRMR resource for the first CLI-RSSI measurement and/or a second CRMR resource for the second CLI-RSSI measurement. A WTRU may determine to report CLI measurement related information, for example when a measured delta-CLI-RSSI is larger than a threshold. CLI reporting may be triggered based on delta-CLI-RSSI measurement is larger than a threshold. The threshold may be predetermined and/or configured.

The WTRU may be configured and/or determined to measure CLI-RSSI per subband level. For example, a subband may be configured, and/or predetermined and/or a WTRU may perform CLI-RSSI measurement in each subband. Subband size may be determined based on the number of scheduled RBs (e.g., for PDSCH). The WTRU may report CLI-RSSI measurement for one or more (e.g., all) subbands; and/or the WTRU may report a subset of CLI-RSSI. The subset may be determined based on one or more conditions (e.g., CLI-RSSI value above threshold, subband location (e.g., edge of scheduled RBs), and/or subband index).

The WTRU may determine a bandwidth of beam measurement/reporting (e.g., wideband or subband) based on one or more condition. For example, the one or more condition may include a time unit type (e.g., SBFD or non-SBFD) and/or the presence of CLI-RSSI measurement. A WTRU may report wideband CRI (e.g., wideband beam index) in non-SBFD time units (e.g., symbol, slot, and so forth) and/or the WTRU may report subband CRI (e.g., subband beam index) in SBFD time units. The bandwidth of beam measurement/reporting may be determined based on whether CLI-RSSI is measured in the same slot or not.

The WTRU may be indicated to perform CLI-RSSI measurement in a specific frequency location. The specific frequency location may be within a scheduled RBs (or non-scheduled RBs). Additionally, or alternatively, the specific frequency location may be included in one or more of subbands, RBs, and/or REs. The indication may be in a DCI which, for example may trigger the CLI-RSSI measurement (e.g., aperiodic CLI-RSSI measurement). The specific frequency location may be indicated based on the CRMR resource frequency location. One or more CRMR resources may be configured and/or each CRMR resource may be located in a specific frequency location based on configuration. The WTRU may be indicated to perform measurement on CRMR resource indicated in a DCI.

A WTRU may receive a physical broadcast channel (PBCH). The PBCH may be part of an SS/PBCH block (SSB). The PBCH may carry system information. The PBCH may include and/or carry a master information block (MIB). The term MIB may be associated with (e.g., used to represent) the content, information, payload, and/or bits carried by the PBCH. PBCH and MIB may be used interchangeably herein. The WTRU may use the information in MIB on the time and/or frequency resources to find one or more system information blocks (SIB). The WTRU may use the information in MIB on the time and/or frequency resources to find one or more SIBs, for example upon detection and/or reception of an SS/PBCH block. The term SIB may be associated with (e.g., used to represent) the content, information, payload, and/or bits. In an example, one or more cell (re)selection parameters may be broadcasted in SIB (e.g., SIB1, SIB2, SIB3, and so forth). The WTRU may detect and/or receive from the serving and/or the newly detected cells.

A WTRU may perform cell selection with or without stored cell information. The cell information may include frequencies and/or cell parameters. A cell may include (e.g., be defined as) a combination of one or more uplink component carriers (CC) and/or one or more downlink component carriers. The WTRU may have (e.g., previously) stored information on one or more cells, for example based on previously received measurement control information elements and/or from previously detected cells. The WTRU may leverage the stored cell information for cell selection, for example if the WTRU has stored cell information.

The WTRU may perform initial cell selection. For example, in case there is no stored information and/or or if a cell search based on the stored information has no results, the WTRU may perform initial cell selection (e.g., where the WTRU has no prior knowledge of the cell parameters). For example, the WTRU may not have knowledge of which RF channels are NR frequencies. The WTRU may scan and/or monitor one or more RF channels. The one or more RF channels may be from a set of RF channels (e.g., based on the synchronization raster frequencies), for example in the NR bands. The WTRU may scan and/or monitor one or more RF channels to find a suitable cell. For example, a synchronization raster may indicate the frequency positions of the synchronization block (e.g., SS/PBCH block). The synchronization block may be used by the WTRU, for example, for system acquisition when explicit signaling of the synchronization block position is not present. The WTRU may search to find the SS/PBCH blocks corresponding to one and more cells on each frequency channel and/or raster. The WTRU may select the strongest cell, for example based on the measuring one or more of the RSSI, RSRP, RSRQ, SINR, and/or etc. for the detected SS/PBCH block.

Herein, the term ‘evaluated parameter’ may be used interchangeably with ‘evaluated RSRP’, ‘evaluated RSRQ’, and/or etc. The term evaluated may be interpreted as adjusted, computed, calculated, compensated, scaled, defined, determined, identified, and/or etc. A WTRU may determine an evaluated parameter based on one or more measured values. For example, the WTRU may determine an evaluated parameter based on one or more measured values and/or (e.g., along with) one or more compensation and/or scaling parameters (e.g., (pre)configured and/or indicated parameters). The WTRU may calculate the addition, subtraction, multiplication, and/or division of one or more measured values with one or more compensation and/or scaling parameters, for example to determine the corresponding evaluated parameter.

The WTRU may select a cell (e.g., a suitable cell) as the serving cell. The WTRU may select a cell (e.g., a suitable cell) as the serving cell, for example upon finding a suitable cell. The WTRU may use one or more criteria to select a candidate cell as a suitable cell. The WTRU may determine the criteria based on one or more evaluated parameters. The WTRU may determine the evaluated parameters based on one or more of measured parameters, compensation values, scaling rules, and/or etc. The WTRU may determine the compensation values and/or scaling rules based on one or more configured and/or indicated offsets, parameters, and/or configured values. The WTRU may be configured with and/or determine one or more of measured cell received level value; measured cell quality value; minimum required measured Rx level and/or quality level in a cell; compensation values; evaluated cell (re)selection Rx level value; and/or evaluated cell (re)selection quality value.

The WTRU may be configured with, and/or determine measured cell received level value. For example, the WTRU may measure one or more of the reference signal received power (RSRP), signal-to-noise and interference ratio (SINR), received signal strength indicator (RSSI), and/or etc., for example for one or more SS/PBCH blocks, reference signals, and/or channels. The WTRU may be configured with, and/or determine measured cell quality value. For example, the WTRU may measure one or more of the reference signal received quality (RSRQ) for one or more SS/PBCH blocks, reference signals, and/or channels. The WTRU may be configured with and/or determine minimum required measured RX level and/or quality level in a cell. For example, a WTRU may receive, determine, and/or be configured with one or more parameters and/or offset values to determine the minimum required Rx level (e.g., in dBm) and/or minimum required quality level (e.g., dB) in the corresponding cell. The WTRU may be configured with and/or determine compensation values. The WTRU may receive, determine, and/or be configured with one or more parameters, offset, and/or scaling values that, for example may be used upon receiving an indication, and/or based on WTRU determining based on one or more modes of operation, thresholds, and/or etc. The WTRU may be configured with and/or determine evaluated cell (re)selection Rx level value. For example, the WTRU may compute, evaluate, and/or calculate the received level value (e.g., in dB) based on one or more measured parameters and/or compensation and/or scaling values.

The WTRU may calculate the evaluated cell (re)selection Rx level value (e.g., Srxlev) based on one or more of the measured cell received level value (e.g., Qᵣₓₗₑᵥₘₑₐₛ), the minimum required measured Rx level (e.g., Qᵣₓₗₑᵥₘᵢₙ and/or Q_{rxlevminoffset}), the compensation parameters (e.g., P_{compensation}), one or more temporary offset values (e.g., Qoffsetₜₑₘₚ), and/or etc. (e.g., Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ). The WTRU may select the corresponding cell as one of the candidate suitable cells, for example if the evaluated cell (re)selection Rx level value is higher than a (pre)configured threshold (e.g., Srxlev>0 for cell selection, or Srxlev>SintraSearchP or Srxlev>SnonIntraSearchP for intra-frequency and inter-frequency, respectively, cell reselection, and so forth). The WTRU may be configured with and/or determine evaluated cell (re)selection quality value. For example, the WTRU may compute, evaluate, and/or calculate the received quality value (e.g., in dB) based on one or more measured parameters and/or compensation and/or scaling values. The WTRU may calculate the evaluated cell (re) selection quality value (e.g., Squal) based on one or more of the measured cell quality value (e.g., Q_{qualmeas}), the minimum required quality level (e.g., Q_{qualmin} and/or Q_{qualminoffset}), one or more temporary offset values (e.g., Qoffsetₜₑₘₚ), and/or etc. (e.g., Squal=Q_{qualmeas}−(Q_{qualmin}+Q_{qualminoffset})−Qoffsetₜₑₘₚ). The WTRU may select the corresponding cell as one of the candidate suitable cells, for example if the evaluated cell (re)selection quality value is higher than a (pre)configured threshold (e.g., Squal>0, or Squal>SintraSearchQ, or Squal>SnonIntraSearchQ for intra-frequency and inter-frequency, respectively, cell reselection, and so forth).

The WTRU may receive and/or be configured with one or more of the compensation and/or scaling parameters, values, settings, and/or rules, for example as criteria for cell (re)selection (e.g., via implicit and/or explicit indications). The explicit indications may be via one or more of a master information block (MIB) in corresponding SS/PBCH block, system information blocks (SIB1, SIB2, SIB3, SIB4, and so forth), semi-static configuration (e.g., via RRC), dynamic indication (e.g., via MAC-CE and/or DCI), and/or etc. The WTRU may determine to use one or more compensation and/or scaling rules based on implicit indication, for example based on comparing one or more parameters with corresponding thresholds.

A WTRU may perform cell ranking for one or more (e.g., all) the cells (e.g., serving and neighbor cells). The WTRU may perform cell ranking for one or more (e.g., all) the cells (e.g., serving and neighbor cells) that the WTRU determined as the candidate suitable cells based on the cell selection criterion, for example upon measuring and/or calculating the evaluated received power and/or evaluated quality value. Additionally, or alternatively, the WTRU may determine the cell ranking based on the calculating the R values using average RSRP results. The following parameters are non-limiting examples of the parameters that may be included in cell ranking calculation and measurement. One or more of these parameters may be included. Other parameters may be included. One or more of the following may apply.

$${R}_{s} = {Q}_{meas , s} + {Q}_{hyst} - {Qoffset}_{temp}$$

$${R}_{n} = {Q}_{meas , n} + Qoffset - {Qoffset}_{temp}$$

Rs and Rn may correspond to the serving and neighbor cells, respectively. Q_{hyst} may represent the mobility aspects of the WTRU. Qoffset may be configured with different values, for example for intra-frequency and inter-frequency cell (re) selections. Qₘₑₐₛ may include (e.g., be) the measured RSRP quantity used in cell (re)selection.

The WTRU may reselect a new candidate cell, for example if the new cell has higher R value than the serving cell during a (pre)configured time interval. A WTRU may determine the downlink SS/PBCH block energy per resource element (EPRE). For example, the WTRU may determine the downlink SS/PBCH block EPRE based on the received SS/PBCH downlink transmit power. The WTRU may receive, determine, identify, and/or be provided with SS/PBCH downlink transmit power (e.g., from a gNB) (e.g., by the parameter ss-PBCH-BlockPower provided by higher layers). The downlink transmit power for the secondary synchronization signal (SSS) may include (e.g., be defined as) the linear average over the power contributions (e.g., in [W]) of one or more (e.g., all) resource elements that carry the SSS within the operating system bandwidth.

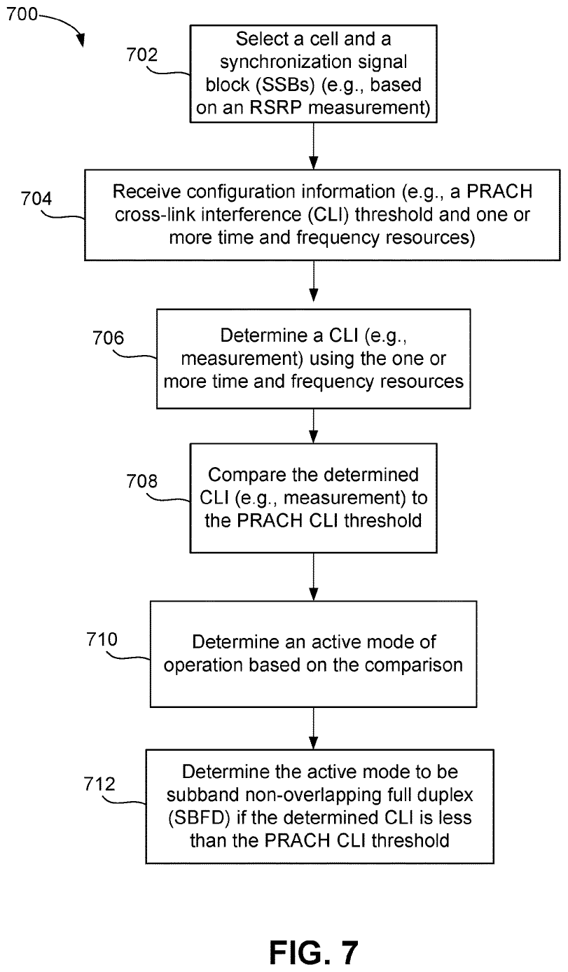

FIG. 7 is a diagram illustrating an example procedure 700 for determining an active mode of operation. A WTRU may determine a mode of operation, for example in initial access. A WTRU (e.g., an SBFD-capable WTRU) may detect one or more SSBs from a cell (e.g., during initial access). At 702 a WTRU may select a cell and a synchronization signal block (SSB) associated with the cell, for example based on a reference signal received power (RSRP) measurement. The WTRU may determine whether the cell supports SBFD operation (e.g., from a broadcast message such as MIB, SIB1, SIB2, etc.). For example, the WTRU may flag indication for enabling SBFD operation. For example, the WTRU may receive the time and frequency resources for SBFD operation (e.g., via the broadcast message, MIB, SIB, etc.) (e.g., DL subbands, UL subbands, time pattern, periodicity, time units, e.g., symbols, slots, etc.)

At 704 the WTRU may receive configuration information (e.g., via the broadcast message, MIB, SIB, etc.), for example to measure CLI (e.g., reference signals, time and frequency resources, etc. to measure CLI-RSSI), and/or that indicates a threshold (e.g., a CLI threshold). The configuration information may include a physical random access channel (PRACH) cross-link interference (CLI) threshold and/or one or more time and frequency resources. The configuration information may include a first indication of one or more first resources for an SBFD active mode of operation and/or a second indication of one or more second resources for a non-SBFD mode of operation. The WTRU may measure the CLI (e.g., CLI-RSSI) based on the configured resources and/or compare with the configured threshold. The configured threshold may include a PRACH CLI threshold. At 706 the WTRU may determine CLI (e.g., CLI measurement) associated with the cell, for example using the one or more time and frequency resources. For example, the WTRU may determine the CLI (e.g., the CLI measurement) associated with the cell based on the configuration information.

At 708 the WTRU may compare the determined CLI (e.g., measurement) with the PRACH CLI threshold. At 710 the WTRU may determine an active mode of operation, for example based on the comparison of the determined CLI measurement to the PRACH CLI threshold. The WTRU may determine an active mode of operation to be SBFD operation for accessing the cell (e.g., WTRU may receive/transmit DL/UL in configured DL/UL subbands in time resources corresponding to SBFD operation, such as for PRACH transmission and/or RAR reception). At 712 the WTRU may determine the active mode of operation to be subband non-overlapping full duplex (SBFD), for example if the determined CLI measurement is less than the PRACH CLI threshold.

The WTRU may transmit a PRACH message to a base station, for example using the one or more first resources. The PRACH message may include an indication that the WTRU supports SBFD. Additionally, or alternatively, the PRACH message may include an indication that the active mode of operation of the WTRU is SBFD. The WTRU may transmit a preamble (e.g., PRACH preamble) to the base station using the one or more first resources, for example before transmitting the PRACH message. The preamble may indicate whether the WTRU supports SBFD. The preamble may include an indication that the WTRU supports SBFD. For example, the preamble may be the indication that the WTRU supports SBFD. Additionally, or alternatively, the preamble may include an indication that the active mode of operation of the WTRU is SBFD. The WTRU may transmit the PRACH message to a base station using the one or more second resources. The WTRU may transmit the preamble to the base station using the one or more second resources.

The WTRU may transmit a physical uplink shared channel (PUSCH) message, for example using the one or more second resources. The PUSCH message may include an indication that the WTRU supports SBFD. Additionally, or alternatively, the PUSCH message may include an indication that the active mode of operation of the WTRU is SBFD. The WTRU may determine the active mode to be non-SBFD, for example if the determined CLI measurement is greater than or equal to the PRACH CLI threshold. The WTRU may transmit the PRACH message using one or more resources for a non-SBFD active mode of operation. The WTRU may determine the one or more resources for the non-SBFD active mode of operation, for example based on an indication in the configuration information.

The WTRU may include resources in UL subbands of SBFD symbols and/or slots in the set of allowed resources (e.g., the set of allowed RACH occasions) from which it can select, for example when the WTRU selects a resource for transmitting a PRACH preamble. Additionally, or alternatively, the WTRU may select a resource for transmitting a PRACH preamble based on the determination that the active mode of operation is SBFD. The WTRU may monitor in monitoring occasions in DL subbands of SBFD symbols and/or slots. For example, based on the determination that the active mode of operation is SBFD, when the WTRU monitors for a PDCCH indicating an RAR, the WTRU may monitor in monitoring occasions in DL subbands of SBFD symbols and/or slots.

The WTRU may determine the active mode of operation to be non-SBFD operation and/or to use non-SBFD (legacy) configurations for accessing the cell (e.g., the WTRU may receive/transmit DL/UL in configured TDD DL/UL time units, such as for PRACH transmission and/or for RAR reception), for example if the CLI is higher than the threshold. For example, based on the determination that the active mode of operation is non-SBFD, when the WTRU selects a resource for transmitting a PRACH preamble, the WTRU may include resources in UL and/or flexible time units (e.g., symbols and/or slots) (e.g., based on TDD configuration) in the set of allowed resources (e.g., the set of allowed RACH occasions) from which it can select. The WTRU may monitor in monitoring occasions in DL and/or flexible time units (e.g., symbols and/or slots) (e.g., based on TDD configuration). For example, based on the determination that the active mode of operation is non-SBFD, when the WTRU monitors for a PDCCH indicating an RAR, the WTRU may monitor in monitoring occasions in DL and/or flexible time units (e.g., symbols and/or slots) (e.g., based on TDD configuration). The WTRU may transmit (e.g., send) a PRACH preamble using the resources determined, for example based on the active mode of operation.

A WTRU may determine a mode of operation in initial access. The WTRU (e.g., an SBFD-capable WTRU) may detect one or more SSBs from a cell (e.g., during initial access). The WTRU may determine whether the cell supports SBFD operation (e.g., from a broadcast message such as MIB, SIB1, SIB2, etc.). The WTRU may receive configuration information (e.g., via the broadcast message, MIB, SIB, etc.). The configuration information may include an indication to measure CLI (e.g., reference signals, time and frequency resources, etc. to measure CLI-RSSI). Additionally, or alternatively, the configuration information may include a threshold (e.g., a CLI threshold). The WTRU may measure the CLI (e.g., CLI-RSSI) based on the configured resources and/or compare with the configured threshold. The WTRU may determine the active mode of operation to be SBFD operation for accessing the cell (e.g., WTRU may receive/transmit DL/UL in configured DL/UL subbands in time resources corresponding to SBFD operation, such as for PRACH transmission and/or RAR reception), for example if the (e.g., determined) CLI is lower than the threshold. The WTRU may determine the active mode of operation to be non-SBFD operation and/or to use non-SBFD (legacy) configurations for accessing the cell (e.g., the WTRU may receive/transmit DL/UL in configured TDD DL/UL time units, such as for PRACH transmission and/or for RAR reception), for example if the (e.g., determined) CLI is higher than the threshold.

The WTRU may transmit (e.g., send) a PRACH preamble using the resources determined based on the active mode of operation. The WTRU may determine whether the cell supports SBFD operation (e.g., from a broadcast message such as MIB, SIB1, SIB2, etc.). For example, the WTRU may flag indication for enabling SBFD operation. For example, the WTRU may receive the time and/or frequency resources for SBFD operation (e.g., via the broadcast message, MIB, SIB, etc.) (e.g., DL subbands, UL subbands, time pattern, periodicity, time units, e.g., symbols, slots, etc.). In case the CLI is lower than the threshold for example, the WTRU may determine the active mode of operation to be SBFD operation for accessing the cell (e.g., WTRU may receive/transmit DL/UL in configured DL/UL subbands in time resources corresponding to SBFD operation, such as for PRACH transmission and/or RAR reception). For example, based on the determination that the active mode of operation is SBFD, when the WTRU selects a resource for transmitting a PRACH preamble, the WTRU may include resources in UL subbands of SBFD symbols and/or slots in the set of allowed resources (e.g., the set of allowed RACH occasions) from which it can select. For example based on the determination that the active mode of operation is SBFD, when the WTRU monitors for a PDCCH indicating an RAR, the WTRU may monitor in monitoring occasions in DL subbands of SBFD symbols and/or slots. If the CLI is higher than the threshold, the WTRU may determine the active mode of operation to be non-SBFD operation and/or determine to use non-SBFD (legacy) configurations for accessing the cell (e.g., the WTRU may receive/transmit DL/UL in configured TDD DL/UL time units, such as for PRACH transmission and/or for RAR reception). For example, based on the determination that the active mode of operation is non-SBFD, when the WTRU selects a resource for transmitting a PRACH preamble, the WTRU may include resources in UL and/or flexible time units (e.g., symbols and/or slots) (e.g., based on TDD configuration) in the set of allowed resources (e.g., the set of allowed RACH occasions) from which it can select. Based on the determination that the active mode of operation is non-SBFD for example, when the WTRU monitors for a PDCCH indicating an RAR, the WTRU may monitor in monitoring occasions in DL and/or flexible time units (e.g., symbols and/or slots) (e.g., based on TDD configuration).

A WTRU may determine and/or receive configuration and/or indications (e.g., from a gNB) for the active mode of operation. The indication for the modes of operation may be based on implicit and/or explicit indications. The active mode of operation may include SBFD operation or non-SBFD operation.

In SBFD operation for example, the WTRU may receive one or more configurations on the time resources where the SBFD is configured (e.g., symbols, slots, subframes, time units, and so forth). The WTRU may receive the direction of transmission (e.g., DL and/or UL) in one or more frequency resources (e.g., subbands, RBs, BWPs, and so forth) in the configured SBFD time units. The WTRU may be configured with one or more UL and/or DL subbands in an SBFD time unit.

A WTRU (e.g., that is configured with one or more SBFD time units), may be configured, scheduled, and/or indicated with one or more DL reception and/or UL transmission configurations in the configured SBFD symbol. The one or more DL reception and/or UL transmission configurations may include a UL transmission within the UL subbands; a DL reception within the DL subbands; a UL transmission outside of the UL subbands (e.g., within DL subbands; and/or a DL reception outside of the DL subbands (e.g., within the UL subbands). The WTRU (e.g., that is configured with one or more SBFD time units), may be configured, scheduled, and/or indicated with UL transmission within the UL subbands. For example, the WTRU may be scheduled to transmit an UL message within the UL subbands in an SBFD symbol. The WTRU (e.g., that is configured with one or more SBFD time units), may be configured, scheduled, and/or indicated with DL reception within the DL subbands. The WTRU may monitor for one or more DL messages (e.g., PDCCH) within configured DL subbands in an SBFD symbol. The WTRU may be configured and/or scheduled to receive one or more DL messages (e.g., PDSCH, CSI-RS, PT-RS, TRS, and so forth) within the DL subbands in an SBFD symbol. The WTRU (e.g., that is configured with one or more SBFD time units), may be configured, scheduled, and/or indicated with UL transmission outside of the UL subbands (e.g., within DL subbands). For example, the WTRU may be scheduled to transmit a UL message outside of the UL subbands in an SBFD symbol. The WTRU (e.g., that is configured with one or more SBFD time units), may be configured, scheduled, and/or indicated with DL reception outside of the DL subbands (e.g., within the UL subbands). For example, the WTRU may monitor to detect one or more DL messages (e.g., PDCCH) within the UL subbands in an SBFD symbol. The WTRU may be scheduled and/or configured to receive one or more DL messages (e.g., PDSCH, CSI-RS, PT-RS, TRS, and so forth) outside of the DL subbands and/or within UL subbands.

The WTRU may monitor or be scheduled and/or configured to receive one or more DL messages in configured SBFD time units, for example in non-SBFD operation. The WTRU may monitor or be scheduled and/or configured to receive one or more DL messages in TDD DL and/or TDD flexible time units. The WTRU may be scheduled and/or configured to transmit one or more UL messages in configured SBFD time units. The WTRU may be scheduled and/or configured to transmit one or more UL messages in TDD UL and/or TDD flexible time units.

The WTRU may operate as in legacy TDD operation. For example, the WTRU may receive one or more configurations on the time resources. UL, DL, and/or flexible time units may be configured (e.g., symbols, slots, subframes, time units, and so forth), for example in non-SBFD operation. A WTRU that is configured with non-SBFD operation, may be configured, scheduled, and/or indicated with one or more of DL reception or UL transmission configurations. The one or more DL reception or UL transmission configurations may include a UL transmission in the TDD UL and/or TDD flexible time-units, and/or DL reception in the TDD DL and/or flexible time-units. A WTRU that is configured with non-SBFD operation, may be configured, scheduled, or indicated with UL transmission in the TDD UL and/or TDD flexible time-units. For example, the WTRU may be scheduled to transmit an UL message within the UL and/or flexible time units (e.g., symbols, slots, subframe, and so forth). A WTRU that is configured with non-SBFD operation, may be configured, scheduled, or indicated with DL reception in the TDD DL and/or flexible time-units: For example, the WTRU may monitor for one or more DL messages (e.g., PDCCH) in TDD DL and/or flexible time-units (e.g., symbols, slots, subframe, and so forth). The WTRU may be configured and/or scheduled to receive one or more DL messages (e.g., PDSCH, CSI-RS, PT-RS, TRS, and so forth) in TDD DL and/or flexible time-units (e.g., symbols, slots, subframe, and so forth). The WTRU may determine to not transmit UL messages in TDD DL time units (e.g., WTRU may not expect to be configured to transmit UL messages in TDD DL time units), for example in non-SBFD operation. The WTRU may determine to not monitor and/or receive DL messages in TDD UL time units (e.g., the WTRU may not expect to be configured to receive or monitor for DL messages in TDD UL time units).

In SBFD or non-SBFD operations, the DL reception and/or UL transmission examples may include one or more of monitoring to detect CORESET #0, CSS, SIB1, SIB2, and/or etc.; monitoring PDCCH, CSI-RS, PT-RS, TRS, and/or other DL reference signals; receiving scheduled and/or configured DL messages (e.g., PDSCH); transmitting PRACH, Msg3, MsgA, PUCCH, PUSCH, SRS, and/or other UL messages and/or reference signal(s); and/or etc.

A WTRU may determine the mode of operation, for example in initial access with SBFD operation. A WTRU may configure the mode of operation, for example in initial access. A WTRU (e.g., an SBFD-capable WTRU) may receive and/or detect a physical broadcast channel (PBCH) from a cell (e.g., during initial access). The PBCH may carry system information. The PBCH may include and/or carry a master information block (MIB). The term MIB may be used to represent the content, information, payload, and/or bits carried by the PBCH. PBCH and MIB may be used interchangeably herein. The PBCH may be part of an SS/PBCH block (SSB). The PBCH may include one or more information bits, for example to detect the CORESET #0 and/or common search space (CSS) to (monitor to) find the first system information block (SIB) (e.g., SIB1). The SIB1 may include information content to monitor and/or detect other SIBs.

A synchronization raster may indicate the frequency positions of the synchronization block (e.g., SSB). The frequency positions of the SSB may be used by the WTRU for system acquisition (e.g., when explicit signaling of the synchronization block position is not present). Herein, a frequency raster may be referred to as channel raster and/or synchronization raster (e.g., sync raster). Operating frequency band, physical carrier, physical carrier band, and/or system band may be interchangeably used.

A WTRU may receive an indication (e.g., flag indication) from a cell (e.g., via MIB, SIB, and so forth), for example indicating if the cell operates in a first mode of operation (e.g., SBFD operation) and/or a second mode of operation (e.g., non-SBFD and/or legacy TDD operation). The WTRU may determine the mode of the operation in the cell based on one or more of implicit indication and/or explicit indication. The WTRU may determine the mode of the operation in the cell based on implicit indication (e.g., sync raster). For example, the WTRU may implicitly determine the mode of operation of the cell based on the sync raster corresponding to the received and/or detected SSB. One or more sync raster sets may be used, defined, configured, and/or determined and/or each of sync raster sets may be a subset of a channel raster. A sync raster set may be mutually exclusive to another sync raster set. The WTRU may determine that the cell operates in the first mode of operation (e.g., SBFD operation), for example if the sync raster corresponding to the received and/or detected SSB is in a first sync raster set. The WTRU may determine that the cell operates in the second mode of operation (e.g., non-SBFD operation), for example if the sync raster corresponding to the received and/or detected SSB is in a second sync raster set, and so forth. The WTRU may determine the mode of the operation in the cell based on an explicit indication (e.g., MIB). For example, the WTRU may receive an explicit indication in MIB indicating the mode of operation for the cell.

The WTRU may receive an explicit indication in SIB1 that, for example may indicate the mode of operation for the cell. The WTRU may (e.g., blindly) detect the CORESET #0 and/or Type0-PDCCH CSS, for example based on the different interpretation of the MIB parameters for different modes of operation. Additionally, or alternatively, the WTRU may (e.g., blindly) detect the CORESET #0 and/or Type0-PDCCH CSS, when explicit signaling of the mode of operation is not present or cannot be decoded from MIB. The WTRU may (e.g., blindly) determine the mode of operation to be non-SBFD and/or attempt to detect the CORESET #0 and Type0-PDCCH CSS based on the received MIB parameters (e.g., in TDD DL or flexible time units). Alternatively, or additionally, the WTRU may (e.g., blindly) determine the mode of operation to be SBFD and/or attempt to detect the CORESET #0 and Type0-PDCCH CSS based on the received MIB parameters (e.g., in TDD DL, UL, and/or flexible time units).

A WTRU may receive a configuration from a cell (e.g., via SIB) indicating the time units and/or the frequency resources (e.g., subbands, RBs, BWPs, and so forth). The first mode of operation (e.g., SBFD operation) may be applied. The WTRU may receive a configuration from the cell (e.g., via SIB). The configuration may indicate the direction of UL/DL transmission and/or reception in the configured frequency resources. The indication may include one or more of time units; UL and DL subbands; time pattern; and/or periodicity. For example, the WTRU may be configured with the time units (e.g., symbols, slots, subframes, and so forth) where the first mode of operation is configured (e.g., SBFD operation). The WTRU may be configured with the time units for TDD operation (e.g., TDD DL, TDD UL, and/or TDD flexible time units). UL and DL subbands may be indicated. For example, the WTRU may be configured with the frequency resources (e.g., subbands, RBs, BWPs, and so forth) for UL transmission and/or DL reception in the configured time units with the first mode of operation (e.g., SBFD symbols, slots, and/or etc.). A time pattern may be indicated. For example, the WTRU may be configured with one or more time patterns to use for the configuration of the time units for the application of the first mode of operation (e.g., SBFD operation). A periodicity may be indicated. For example, the WTRU may be configured with a time period to be used for the configuration of the first mode of operation to be repeated over time resources (e.g., SBFD operation). Configuration and configuration information may be used interchangeably herein.

A WTRU may perform and/or receive one or more CLI measurement, for example during initial access. A WTRU (e.g., during initial access) may receive (e.g., via the broadcast message, MIB, SIB, and so forth) one or more configurations on one or more reference signals and/or time and frequency resources to measure CLI (e.g., in a detected cell), (e.g., as described herein). The WTRU may be (pre)configured or receive one or more CLI thresholds (e.g., from a cell).

The WTRU may determine (e.g., identify, be configured with, or be indicated with) one or more measurement resource(s) for CLI measurement (e.g., for deriving/reporting L1/L2 CLI-RSSI). The one or more measurement resource(s) may be associated with a cell (e.g., TRP, CC, gNB, node, transmitter, and/or receiver). The one or more measurement resource(s) may include one or more of one or more zero-power (ZP) (e.g., ZP CSI-RS) resource(s); one or more SS/PBCH block(s); a measurement of the received power for the received reference signal (e.g., SSB-RSRP); and/or one or more pre-defined or pre-configured time, frequency, spatial, sequence-domain resource(s), and/or reference signals.

The one or more measurement resource(s) may include one or more zero-power (ZP) (e.g., ZP CSI-RS) resource(s). The one or more ZP resources may be identified from MIB, SIB, etc., and/or an explicit signal sent and/or broadcasted from the cell. The one or more measurement resource(s) may include one or more SS/PBCH block(s). For example, the WTRU may measure and use one or more parameters based on the received SSB for calculating the CLI power and/or strength (e.g., CLI-RSSI). For example, the WTRU may use the measurements for deriving and/or estimating reference signal and/or channel's received power (e.g., SSB-RSRP) in addition, or in the alternative, to the measured received signal strength and/or power (e.g., SSB-RSSI) to calculate the received interference strength (e.g., CLI-RSSI). The one or more measurement resource(s) may include the measurement of the received power for the received reference signal (e.g., SSB-RSRP). The SSB-RSRP may include (e.g., be considered as) the desired received power. The received signal strength (e.g., SSB-RSSI) may include (e.g., be considered as) the total received signal strength. Additionally, or alternatively, the SSB-RSSI may include (e.g., both) desired signals power and/or the interference. The interference strength may be estimated based on measured SSB-RSRP and/or SSB-RSSI for respective SSB.

The WTRU may measure the CLI (e.g., in the cell), for example based on the configured reference signals and the configured time and frequency resources. The WTRU may compare the measure CLI with a configured CLI threshold. A WTRU may determine that the measured CLI is (e.g., equal to) or less than the configured CLI threshold. The WTRU may determine the (e.g., active) mode of operation (e.g., in the detected cell) to be the first mode of operation (e.g., SBFD), for example based on the measured CLI (e.g., being equal to or less than the configured CLI threshold). The WTRU may use, select, and/or determine the DL and/or UL resources based on the configured resources for the SBFD mode of operation (e.g., as described herein).

The WTRU may select the resources for transmitting a PRACH preamble. For example, the WTRU may select the resources for transmitting a PRACH preamble based on the configured UL subbands in SBFD symbols. Additionally, or alternatively, the WTRU may select the resources for transmitting a PRACH preamble based on determining that the active mode of operation is SBFD. Alternatively, or additionally, the WTRU may select the resources for transmitting a PRACH preamble based on the set of resources (e.g., the set of allowed RACH occasions). The set of resources may include resources the WTRU is allowed to select from.

The WTRU may select the resources for monitoring a PDCCH (e.g., indicating a RAR). For example, the WTRU may select the resources for monitoring a PDCCH based on determining that the active mode of operation is SBFD. The WTRU may monitor the resources in DL subbands in SBFD symbols. Alternatively, or additionally, the WTRU may select the resources for monitoring the PDCCH based on the set of resources (e.g., the set of allowed PDCCH occasions). The set of resources may include resources the WTRU is allowed to monitor.

A WTRU may determine that the measured CLI is equal to and/or higher than the configured CLI threshold. The WTRU may determine the (e.g., active) mode of operation (e.g., in the detected cell) to be the second mode of operation (e.g., non-SBFD). The WTRU may use, select, and/or determine the DL and/or UL resources, for example based on the configured resources for the TDD (e.g., legacy) operation (e.g., based on configured DL, UL, or flexible time units, symbols, slots, and so forth).

The WTRU may select the resources for transmitting a PRACH preamble based on the configured UL and/or flexible time units (e.g., symbols, slots, subframes, and so forth) (e.g., based on TDD configurations). Additionally, or alternatively, the WTRU may select the resources for transmitting a PRACH preamble based on the configured UL and/or flexible time units based on determining that the active mode of operation is non-SBFD. Alternatively, or additionally, the WTRU may select the resources for transmitting a PRACH preamble based on the set of resources (e.g., the set of allowed RACH occasions). The set of resources may include resources the WTRU is allowed to select from.

The WTRU may select one or more resources for monitoring a PDCCH (e.g., indicating a RAR), for example based on the configured DL and/or flexible time units (e.g., symbols, slots, subframes, and so forth) (e.g., based on TDD configurations). Additionally, or alternatively, the WTRU may select the resources for monitoring a PDCCH based on determining that the active mode of operation is non-SBFD. Alternatively, or additionally, the WTRU may use, select, and/or determine the resources for monitoring the PDCCH based on the set of resources (e.g., the set of allowed PDCCH occasions). The set of resources may include resources the WTRU is allowed to select from. The WTRU may connect to the detected cell by sending a PRACH preamble, for example using the selected resources based on the determined mode of operation.

The WTRU may select one or more candidate cells based on one or more CLI levels. A WTRU (e.g., an SBFD-capable WTRU) may detect one or more SSBs from a cell (e.g., during cell search). The cell may include (e.g., be) a candidate cell used for cell (re)selection (e.g., RSRP>threshold1, RSRQ>threshold2, etc. based on cell ranking specifications). The WTRU may determine if the cell supports SBFD (e.g., based on received and/or configured flag indication, time and/or frequency resources allocated to SBFD, etc. via MIB, SIB, etc.). The WTRU may receive the SBFD information from the cell and/or the serving cell that WTRU is already camping on. The WTRU may receive configuration for measuring CLI in SBFD resources for each of at least one of the detected SSBs (e.g., via the MIB, SIB, etc.), and/or one or more thresholds (e.g., RSRP, CLI thresholds). The WTRU may measure CLI (e.g., CLI-RSSI) based on the configuration.

The WTRU may select one or more SSBs (e.g., best SSBs) from the detected SSBs. The WTRU may select the one or more SSBs based on one or more of measured RSRP and/or measured CLI (e.g., combination of the measured RSRP and measured CLI); measured CLI (e.g., lowest CLI); and/or measured RSRP (e.g., highest RSRP). The WTRU may select one or more SSBs (e.g., best SSBs) from the detected SSBs based on measured RSRP and/or measured CLI (e.g., combination of the measured RSRP and measured CLI). The measured RSRP and/or measured CLI may include one or more of the SSB with highest RSRP and/or lowest CLI; one or more SSBs with an RSRP above an RSRP threshold and/or a CLI below a CLI threshold; and/or one or more highest RSRP SSBs among the SSBs with CLI below a CLI threshold and/or one or more lowest CLI SSBs with RSRP above an RSRP threshold. The WTRU may select one or more SSBs (e.g., best SSBs) from the detected SSBs, for example based on measured CLI (e.g., lowest CLI). The WTRU may select one or more SSBs (e.g., best SSBs) from the detected SSBs based on a measured RSRP (highest RSRP).

The WTRU may compare the measured CLI for the one or more selected (e.g., best) SSBs (e.g., SSB beams), for example for the cell with a CLI threshold (e.g., same or different from the CLI threshold used for SSB selection). Additionally, or alternatively, the WTRU may determine to include the cell in the list of candidate cells to be used in cell ranking for SBFD operation, for example if the measured CLI of an SSB (e.g., at least one SSB) of the one or more selected SSBs is lower than the CLI threshold. Additionally, or alternatively, the WTRU may determine to not consider the cell as a candidate for SBFD operation (e.g., for a time duration), for example if the measured CLI of each of the one or more selected SSBs is higher than the CLI threshold. The WTRU may measure and/or determine conditional barred cells for SBFD operation as described herein.

The WTRU may perform cell ranking for the candidate cells (e.g., jointly or separately for SBFD and/or non-SBFD cells) (e.g., based on measured and/or evaluated RSRP, RSRQ, number of beams, etc.) The WTRU may select the cell with highest ranking to camp on, for example based on cell selection configurations and/or priority configurations. The WTRU may determine the active mode of operation to be SBFD, for example if the selected cell supports SBFD operation (e.g., supports or uses DL/UL subbands in SBFD time units). The WTRU may determine the active mode of operation to be non-SBFD, for example if the selected cell operates in non-SBFD mode of operation (e.g., time units may only be used for one of DL and UL). The WTRU may transmit (e.g., send) a PRACH to the selected cell (e.g., using resources determined based on the active mode of operation).

A WTRU may Select one or more candidate cells based on CLI levels. The WTRU (e.g., an SBFD-capable WTRU) may detect one or more SSBs from a cell (e.g., during cell search). The cell may include (e.g., be) a candidate cell used for cell (re)selection (e.g., RSRP>threshold1, RSRQ>threshold2, etc., for example based on cell ranking specifications). Additionally, or alternatively, the WTRU may determine if the cell supports SBFD (e.g., based on received and/or configured flag indication, time and/or frequency resources allocated to SBFD, etc. via MIB, SIB, etc.). For example, the WTRU may receive the SBFD information from the cell and/or the serving cell that WTRU is already camping on.

Additionally, or alternatively, the WTRU may receive one or more configurations for measuring CLI in SBFD resources for each of at least one of the detected SSBs (e.g., via the MIB, SIB, etc.), and/or one or more thresholds (e.g., RSRP, CLI thresholds). Additionally, or alternatively, the WTRU may measure CLI (e.g., CLI-RSSI) based on the configuration. Additionally, or alternatively, the WTRU may select one or more SSBs (e.g., best SSBs) from the detected SSBs based on one or more of measured CLI (e.g., lowest CLI); measured RSRP (e.g., highest RSRP) (e.g., fallback); and/or measured RSRP and/or measured CLI (e.g., combination of the measured RSRP and measured CLI). For example, the measured RSRP and/or measured CLI (e.g., combination of the measured RSRP and measured CLI) may include one or more of the SSB with highest RSRP and/or lowest CLI; one or more SSBs with RSRP above an RSRP threshold and CLI below a CLI threshold; and/or one or more highest RSRP SSBs among the SSBs with CLI below a CLI threshold and/or one or more lowest CLI SSBs with RSRP above an RSRP threshold.

The WTRU may compare the measured CLI for the one or more selected (e.g., best) SSBs (e.g., SSB beams) for the cell with a CLI threshold (e.g., same or different from the CLI threshold used for SSB selection). The WTRU may determine if the measured CLI of an SSB (e.g., at least one SSB) of the one or more selected SSBs is lower than the CLI threshold. The WTRU may determine to include the cell in the list of candidate cells to be used in cell ranking for SBFD operation/The WTRU may determine if the measured CLI of each of the one or more selected SSBs is higher than the CLI threshold The WTRU may determine to not consider the cell as a candidate for SBFD operation (e.g., for a time duration). For example, the WTRU may measure and/or detect conditional barred cells for SBFD operation as described herein.

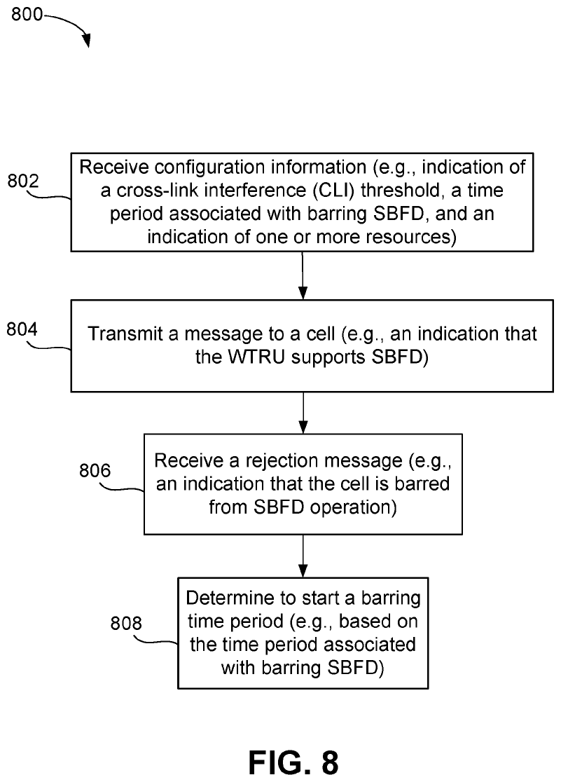

FIG. 8 is a diagram illustrating an example procedure 800 for determining to start a barring time period. At 802 a WTRU may receive configuration information. The configuration information may include one or more of an indication of a cross-link interference (CLI) threshold, a time period associated with barring sub-band non-overlapping full duplex (SBFD), and/or an indication of one or more resources. At 804 the WTRU may transmit a message to a cell. The message may include an indication that the WTRU supports SBFD. At 806 the WTRU may receive a rejection message. The rejection message may include an indication that the cell is barred from SBFD operation. At 808 the WTRU may determine to start a barring time period based on the time period associated with barring SBFD.

The WTRU may perform cell ranking for the candidate cells (e.g., jointly or separately for SBFD and/or non-SBFD cells) (e.g., based on measured and/or evaluated RSRP, RSRQ, number of beams, etc.). For example, the WTRU may rank the cell based on at least one of the measured RSRP or the measured RSRQ. The WTRU may measure one or more of reference signal received power (RSRP) and/or reference signal received quality (RSRQ). The WTRU may rank the cell, for example based on at least one of the barring time period and/or on a cross-link interference (CLI) measurement. The WTRU may determine the CLI measurement, for example when the barring time period has expired. The WTRU may determine to include the cell associated with the one or more SSBs in a list of SBFD candidate cells, for example if the measured CLI is less than the CLI threshold.

Additionally, or alternatively, the WTRU may select the cell with highest ranking to camp on, for example based on cell selection configurations and priority configurations. The WTRU may determine the active mode of operation to be SBFD, for example if the selected cell supports SBFD operation (e.g., supports or uses DL/UL subbands in SBFD time units). The WTRU may determine the active mode of operation to be non-SBFD, for example if the selected cell operates in non-SBFD mode of operation (e.g., time units may only be used for one of DL and UL). The WTRU may select the first cell and/or a second cell based on the ranking, for example if the cell includes a first cell. Additionally, or alternatively, the WTRU may transmit (e.g., send) a PRACH to the selected cell, for example to the first cell and/or the second cell (e.g., using resources determined based on the active mode of operation).

A WTRU may perform a cell search for SBFD operation and/or a CLI measurement. A WTRU (e.g., an SBFD-capable WTRU) may detect one or more SS/PBCH blocks (SSB) from a cell (e.g., during cell search). The cell may be a candidate cell used for cell (re)selection. The candidate cell may be a valid cell, for example based on one or more of RSRP, RSRQ, and/or a cell ranking configuration (e.g., as described herein). The candidate cell may be a valid cell, where for example he measured and/or evaluated RSRP may be higher than a corresponding (pre)configured threshold. The candidate cell may be a valid cell, where for example the measured and/or evaluated RSRQ may be higher than a corresponding (pre)configured threshold. The WTRU may determine to not consider the cell as an SBFD candidate cell for at least the barring time period. The WTRU may determine to consider the cell as an SBFD candidate cell after expiration of the barring time period. The WTRU may determine to consider the cell as an SBFD candidate cell based on the CLI measurement being less than the CLI threshold.

The WTRU may determine, detect, decode, and/or receive one or more indications (e.g., information content) corresponding to the detected SSBs of the cell (e.g., from the serving cell or the cell WTRU is already camping on, e.g., via the MIB, SIB, explicit message, and so forth). For example, the WTRU may determine (e.g., based on decoding the information content) that the cell supports and/or operates with SBFD operation (e.g., via a flag indication). The WTRU may receive a configuration regarding the cell (e.g., from the serving cell or the cell WTRU is already camping on (e.g., via the MIB, SIB, explicit message, and so forth), for example indicating the time units and the frequency resources (e.g., subbands, RBs, BWPs, and so forth). The first mode of operation (e.g., SBFD operation) may be applied. The WTRU may receive a configuration. The configuration may indicate the direction of UL/DL transmission and/or reception in the configured frequency resources.

The WTRU may measure the interference (e.g., CLI) for the cell, for example based on one or more received configurations. The WTRU may receive one or more indications (e.g., by the information content) that the WTRU has determined, detected, decoded, and/or received for the detected SSBs of the cell (e.g., from the serving cell or the cell WTRU is already camping on) (e.g., via the MIB, SIB, DCI, MAC-CE, RRC, and/or etc.). The indication may include the cell-ID and/or the component carrier (CC) for which the CLI is measured in addition to, or alternatively to one or more of one or more reference signals (e.g., zero-power and/or non-zero-power RS), time, and/or frequency resources for measuring the CLI. The WTRU may receive one or more thresholds (e.g., RSRP, RSRQ, CLI, and so forth). The WTRU may measure the CLI (e.g., CLI-RSSI) based on the received configurations.

A WTRU may perform a candidate SSB measurement and/or selection. The WTRU may select one or more SSBs (e.g., best SSBs) from the detected SSBs in the cell. For example, the WTRU may select one or more SSBs based on one or more of measured RSRP and measured CLI (e.g., a combination of measured RSRP and measured CLI); measured CLI; and/or measured RSRP and/or RSRQ (e.g., fallback). The WTRU may select one or more SSBs based on measured RSRP and measured CLI (e.g., a combination of measured RSRP and measured CLI). The WTRU may select the SSB with the highest measured and/or evaluated RSRP and/or RSRQ, for example where the measured and/or evaluated CLI (e.g., CLI-RSSI) may have the lowest value. The WTRU may select one or more SSBs, for which the measured and/or evaluated RSRP and/or RSRQ is higher than a corresponding threshold, where for example the measured and/or evaluated CLI (e.g., CLI-RSSI) may be lower than a corresponding threshold. For example, the WTRU may select one or more SSBs, for which the measured and/or evaluated RSRP and/or RSRQ is the highest value and the measured and/or evaluated CLI (e.g., CLI-RSSI) is lower than a corresponding threshold. Alternatively, or additionally, the WTRU may select one or more SSBs, for which the measured and/or evaluated CLI (e.g., CLI-RSSI) is the lowest and the measured and/or evaluated RSRP and/or RSRQ is higher than a corresponding threshold. The WTRU may select one or more SSBs based on measured CLI. For example, the WTRU may select the SSB with the lowest measured and/or evaluated CLI (e.g., CLI-RSSI). The WTRU may select one or more SSBs based on measured RSRP and/or RSRQ (e.g., fallback). For example, the WTRU may select the SSB with the highest measured and/or evaluated RSRP and/or RSRQ.

A WTRU may select the mode of operation for a candidate cell. The WTRU may compare the measured and/or evaluated CLI for one or more of the selected (e.g., best) SSBs (e.g., SSB beams), for example for the cell with a configured CLI threshold. The configured CLI threshold may be the same or different from the CLI thresholds used for SSB used for candidate SSBs measurement and/or selection. The WTRU may determine that the measured CLI of an SSB (e.g., at least one SSB) from the one or more selected SSBs in the cell is lower than the configured CLI threshold. Additionally, or alternatively, the WTRU may determine to include the cell in the list of candidate cells to be used in cell ranking for SBFD operation (e.g., based on the determination that the measured CLI of an SSB (e.g., at least one SSB) from the one or more selected SSBs in the cell is lower than the configured CLI threshold).

The WTRU may determine that the measured CLI of an SSB (e.g., at least one SSB) from the one or more selected SSBs in the cell is higher than the configured CLI threshold. The WTRU may determine to not include the cell in the list of candidate cells to be used in cell ranking for SBFD operation, for example for a determined and/or configured time duration (e.g., as described herein). The WTRU may determine to not include the cell in the list of candidate cells to be used in cell ranking for SBFD operation, for example based on the measured CLI of an SSB (e.g., at least one SSB) from the one or more selected SSBs in the cell being lower than the configured CLI threshold) The WTRU may determine to include the cell in the list of candidate cells to be used in cell ranking for non-SBFD operation, for example for a determined and/or configured time duration.

The WTRU may determine at least two lists of candidate cells (e.g., a first list for the cells with SBFD operation and a second cell for the cells without SBFD operation). The WTRU may determine at least two lists of candidate cells (e.g., a first list for the cells with SBFD operation and a second cell for the cells without SBFD operation), for example to implement and/or carry out the cell ranking and the cell (re)selection. The WTRU may perform cell-ranking separately for the different lists (e.g., each list) of the candidate cells. The WTRU may determine one or more highest-ranking cells in the first list (e.g., cells with SBFD operation), one or more highest-ranking cells in the second list (e.g., cells without SBFD operation), and/or so forth. For example, upon performing separate cell-rankings, the WTRU may determine one or more highest-ranking cells in the first list (e.g., cells with SBFD operation), one or more highest-ranking cells in the second list (e.g., cells without SBFD operation), and so forth. Alternatively, or additionally, the WTRU may perform the cell ranking for the cells with different modes of operation jointly (e.g., in a single list). The WTRU may determine one or more highest-ranking cells with the first mode of operation (e.g., SBFD operation), one or more highest-ranking cells with the second mode of operation (e.g., non-SBFD operation), and so forth. For example, upon performing the cell ranking, the WTRU may determine one or more highest-ranking cells with the first mode of operation (e.g., SBFD operation), one or more highest-ranking cells with the second mode of operation (e.g., non-SBFD operation), and so forth.

The WTRU may select the cell (e.g., suitable and/or strongest cell) for the cell (re)selection. The WTRU may select the cell (e.g., suitable and/or strongest cell) for the cell (re)selection based on joint optimization and/or selection for cells with different modes of operation (e.g., with or without SBFD operation). The WTRU may select the suitable cell based on one or more of the measured and/or evaluated parameters; the cell with the highest cell ranking (e.g., RSRP, RSRQ, CLI, and so forth); and/or the configured and/or determined priorities (e.g., SBFD operation with higher priority than the operation without SBFD.

The WTRU may determine the active mode of operation to be SBFD (e.g., as described herein). The WTRU may determine the active mode of operation to be SBFD (e.g., as described herein), for example if the selected cell supports SBFD operation. The WTRU may determine the active mode of operation to be non-SBFD. The WTRU may determine the active mode of operation to be non-SBFD, for example if the selected cell operates in non-SBFD mode of operation. The WTRU may send a PRACH preamble to the selected cell, for example based on the determined mode of operation (e.g., using resources determined based on the determined active mode of operation).

A WTRU may select a 2-step or 4-step random access (RA) and/or SBFD support, for example based on RA. A WTRU (e.g., an SBFD-capable WTRU) may select a cell and/or an SSB of the cell. The WTRU may determine to transmit (e.g., send) PRACH to the selected cell (e.g., that is associated to the selected SSB). The WTRU may receive one or more configurations (e.g., via MIB, SIB, etc.) with, for example, one or more of a PRACH CLI threshold, one or more reference signals, time and/or frequency resources to measure the CLI (e.g., CLI-RSSI). The WTRU may measure the CLI using the reference signal(s) and/or resource(s), and/or compares it with the PRACH CLI threshold. The WTRU may determine to use 2-step RA, for example if the measured CLI is lower than the PRACH CLI threshold. The WTRU may use (e.g., both) RSRP (e.g., of the SSS of the selected SSB) and/or CLI to determine 2-step or 4-step RA. The WTRU may determine to use 2-step RA when the RSRP is above an RSRP threshold and/or the CLI is below the PRACH CLI threshold. For example, the WTRU may use (e.g., both) RSRP (e.g., of the SSS of the selected SSB) and/or CLI to determine 2-step or 4-step RA. The WTRU may determine to use 4-step RA, for example when the RSRP is below the RSRP threshold and/or the CLI is above (higher than) the PRACH CLI threshold. The WTRU may perform one or more of transmitting a preamble to the cell, monitoring for a PDCCH indicating a RAR that will provide an UL grant, and/or transmitting (e.g., sending) a message in a PUSCH based on the UL grant. The WTRU may perform one or more of transmitting a preamble to the cell, monitoring for a PDCCH indicating a RAR that will provide an UL grant, and transmitting (e.g., sending) a message in a PUSCH based on the UL grant, for example when the WTRU determines to use 4-step RA. The WTRU may perform one or more of transmitting a MsgA that includes a preamble and/or a PUSCH carrying a message to the cell, and/or monitoring for a PDCCH indicating a MsgB that includes at least one of an RAR and contention resolution information. The WTRU may perform one or more of transmitting a MsgA that includes a preamble and/or a PUSCH carrying a message to the cell, and/or monitoring for a PDCCH indicating a MsgB that includes at least one of an RAR and contention resolution information, for example when the WTRU determines to use 2-step RA.

A WTRU may indicate an active mode of operation, for example based on a PRACH transmission. The WTRU may select a cell and/or an SSB (e.g., based on at least RSRP measurements). The WTRU may be configured (e.g., via MIB, SIB, etc.) with a PRACH CLI threshold and/or one or more reference signals and time and frequency resources, for example to measure the CLI (e.g., CLI-RSSI). The WTRU may be configured with a first PRACH CLI threshold for determining 2-step RA or 4-step RA and/or a second PRACH CLI threshold may be used for determining whether to use and/or indicate support for SBFD or non-SBFD mode, for example when a PRACH CLI threshold is used for determining whether to use 2-step RA or 4-step RA. The thresholds may be the same or different and/or one threshold may be used for both determinations. The WTRU may receive configuration information (e.g., via MIB, SIB, etc.). The configuration information may indicate resources in time and/or frequency, for example for one or more random-access occasions (RO). The configuration information may indicate resources (e.g., ROs) that may be used when the active mode is SBFD and/or resources (e.g., ROs) that may be used when the active mode is non-SBFD (e.g., a first index to a first table or list of parameters for SBFD and a second index to a second table or list of parameters for non-SBFD for determining the ROs). The WTRU may measure the CLI (e.g., CLI-RSSI) and/or compare the measured CLI with the PRACH CLI threshold. For example, the WTRU may measure the CLI based on the resources configured for CLI measurement and/or compare the measured CLI with the PRACH CLI threshold.

The WTRU may determine the active mode of operation to be SBFD and transmits a PRACH, for example if the CLI is lower than the PRACH CLI threshold. Additionally, or alternatively, the WTRU may transmit the PRACH using an RO from the ROs that may be used for SBFD mode based on the configuration (e.g., an RO based on the first table or list). For example, use of an RO indicated for use with SBFD may implicitly indicate to the gNB that the WTRU supports SBFD operation. The WTRU may transmit a preamble in the RO where the preamble indicates (e.g., is from a set that indicates) to the gNB that the WTRU supports SBFD operation. Additionally, or alternatively, the WTRU may transmit the PRACH using an RO from the ROs that may be used for non-SBFD mode based on the configuration (e.g., an RO based on the second table or list), for example when the first available SBFD RO is later than (e.g., more than a threshold amount of time or time units later than) the first available non-SBFD RO. For example, the WTRU may transmit a preamble in the RO where the preamble indicates (e.g., is from a set that indicates) to the gNB that the WTRU supports SBFD operation. For example, the WTRU may perform one or more of transmitting a preamble in the RO (e.g., that does not inform the gNB that the WTRU supports SBFD), monitoring for RAR (e.g., based on non-SBFD operation), and indicating its support for SBFD separately from the preamble transmission (e.g., in Msg3 or a PUSCH transmitted based on the UL grant in the RAR or another UL grant). The WTRU may transmit a MsgA that includes the PRACH preamble and/or a PUSCH, for example for the case of 2-step RA. The WTRU may include an indication that it supports SBFD in the PUSCH part of the MsgA. The WTRU may determine the active mode of operation to be non-SBFD and/or transmit a PRACH using an RO from the ROs that may be used for non-SBFD mode based on the configuration (e.g., an RO based on the second table or list), for when the CLI is higher than the PRACH CLI threshold.

A WTRU may receive, identify, and/or be configured with one or more PRACH transmission aspects for camping on a cell with SBFD. A WTRU may receive, identify, and/or be configured with time domain resource allocations for the consecutive Ros, for example based on the higher-layer parameter prach-ConfigurationIndex, and/or by msgA-PRACH-ConfigurationIndex (e.g., if configured). These parameters may denote the PRACH configuration index corresponding to tables that include random access parameters. One or more parameters may be derived from the table. The one or more parameters may include a preamble format that may refer to one of the possible formats. The possible formats may include one or more of A1, A2, A3, B1, A1/B1, A2/B2, A3/B3, B4, C0, C2 and/or the preamble format may identify one or more of the corresponding cyclic prefix (CP) duration, sequence part duration, and/or guard time duration (e.g., if applicable). Additionally, or alternatively, the one or more parameters may include a frame number and/or slot number that may indicate the frames that can be used for the PRACH transmission and/or the PRACH slot within the corresponding frame. Additionally, or alternatively, the one or more parameters may include starting symbol that may determine the symbol-level index corresponding to the starting position of the first RO transmission within the PRACH slot. Additionally, or alternatively, the one or more parameters may include a number of PRACH slots within a 60 KHz slot associates (e.g., defines) the number of PRACH slots within the reference PRACH slot (e.g., for higher SCS such as 120 KHz, 480 KHz, 960 kHz, considering the 60 KHz PRACH slot as the reference slot). Additionally, or alternatively, the one or more parameters may include a number of time-domain PRACH occasions within a PRACH slot (Nₜ^{RA,slot}) that may associate (e.g., defines) the number of consecutive ROs that are located within a PRACH slot in time domain. Additionally, or alternatively, the one or more parameters may include a PRACH duration that may correspond to the preamble format implying the number of sequence part within an RO.

A WTRU may receive the frequency domain resource allocations for the ROs based on one or more higher-layer parameters. The one or more higher-layer parameters may include msg1-FrequencyStart and/or msgA-RO-FrequencyStart (e.g., if configured), which for example may indicate the offset of the lowest PRACH transmission occasion in frequency domain with respect to the PRB 0. Additionally, or alternatively, the higher-layer parameters may include msg1-FDM and/or msgA-RO-FDM (e.g., if configured), which for example may indicate the number of PRACH transmission occasions that are FDMed in one time-domain RO. The WTRU may receive, identify, and/or be configured with the number of ROs in frequency domain (M) per each time-domain PRACH occasion based on one or more of the higher-layer parameters msg1-FDM, msg1-FDM-16, or msgA-RO-FDM if configured, msg1-FDM={one, two, four, eight}. The WTRU may number the PRACH frequency resources n_{RA}={0, 1, . . . , M−1}, for example starting from the lowest frequency in increasing order in the initial uplink BWP for example during the initial access or the active uplink BWP (e.g., otherwise). The WTRU may receive the association and/or mapping between the SS/PBCH block indexes and PRACH transmission occasions, for example based on one or more higher layer parameters ssb-perRACH-OccasionAndCB-PreamblesPerSSB={⅛, ¼, ½, 1, 2, 4, 8, 16}. The one or more parameters may indicate the number of SS/PBCH block indexes associated with a PRACH transmission occasion in addition to, or alternative to, the number of preambles per SS/PBCH block index per PRACH occasion.

The WRTU may select a 2-step or 4-step RA. A WTRU (e.g., an SBFD-capable WTRU) may select a cell and/or an SSB of the cell. The WTRU may determine to transmit (e.g., send) PRACH to the selected cell that is associated to the selected SSB. The WTRU may receive one or more of a configuration(s) (e.g., via MIB, SIB, etc.) with a PRACH CLI threshold, one or more reference signals, and/or time and/or frequency resources to measure the CLI (e.g., CLI-RSSI). The WTRU may measure the CLI using the reference signal(s) and/or resource(s) and/or compare it with the PRACH CLI threshold. The WTRU may perform one or more of transmitting a preamble to the cell, monitoring for a PDCCH indicating a RAR that will provide an UL grant, and/or sending a message in a PUSCH based on the UL grant. The WTRU may perform one or more of transmitting a MsgA that includes a preamble and a PUSCH carrying a message to the cell, and/or monitoring for a PDCCH indicating a MsgB that includes at least an RAR and may include contention resolution information.

The WTRU may determine to use 2-step RA, for example when the measured CLI is less than the PRACH CLI threshold. The WTRU may determine to use 2-step RA, for example if the measured CLI is less than the PRACH CLI threshold. For example, the WTRU may use (e.g., both) RSRP (e.g., of the SSS of the selected SSB) and/or CLI to determine 2-step or 4-step RA. The WTRU may determine to use 2-step RA when the RSRP is above an RSRP threshold and/or the CLI is below the PRACH CLI threshold. For example, the WTRU may use (e.g., both) RSRP (e.g., of the SSS of the selected SSB) and/or CLI to determine 2-step or 4-step RA. The WTRU may determine to use 4-step RA, for example when the RSRP is below the RSRP threshold or the CLI is above (e.g., higher than) the PRACH CLI threshold. For example, when the WTRU determines to use 4-step RA, the WTRU may perform one or more of transmitting a preamble to the cell, monitoring for a PDCCH indicating a RAR that will provide an UL grant, and/or sending a message in a PUSCH based on the UL grant. In other examples, when the WTRU determines to use 2-step RA, the WTRU may transmit a MsgA that includes a preamble and a PUSCH carrying a message to the cell and/or monitor for a PDCCH indicating a MsgB that includes at least an RAR and/or may include contention resolution information.

A WTRU may indicate active mode of operation based on a PRACH transmission. The WTRU may select a cell and/or an SSB (e.g., based on at least RSRP measurements). The WTRU may be configured (e.g., via MIB, SIB, etc.) with one or more of a PRACH CLI threshold, one or more reference signals, and/or time and/or frequency resources to measure the CLI (e.g., CLI-RSSI). The WTRU may receive configuration information (e.g., via MIB, SIB, etc.). The configuration information may indicate resources in time and/or frequency for one or more random-access occasions (RO). The WTRU may measure the CLI (e.g., CLI-RSSI) based on the resources configured for CLI measurement and/or compare the measured CLI with the PRACH CLI threshold. The WTRU may determine the active mode of operation to be SBFD and/or transmit a PRACH. The WTRU may determine the active mode of operation to be non-SBFD and/or transmit a PRACH, for example using an RO from the ROs that may be used for non-SBFD mode based on the configuration (e.g., an RO based on the second table or list). The WTRU may be configured (e.g., via MIB, SIB, etc.) with one or more of a PRACH CLI threshold, one or more reference signals, and/or time and/or frequency resources to measure the CLI (e.g., CLI-RSSI). The WTRU may be configured with a first PRACH CLI threshold for determining 2-step RA or 4-step RA and/or a second PRACH CLI threshold may be used for determining whether to use and/or indicate support for SBFD or non-SBFD mode, for example when a PRACH CLI threshold is used for determining whether to use 2-step RA or 4-step RA. The thresholds may be the same or different and/or one threshold may be used for both determinations.

The WTRU may receive configuration information (e.g., via MIB, SIB, etc.). The configuration information may indicate resources in time and/or frequency for one or more random-access occasions (RO). For example, the configuration information may indicate resources (e.g., ROs) that may be used when the active mode is SBFD and/or resources (e.g., ROs) that may be used when the active mode is non-SBFD (e.g., a first index to a first table or list of parameters for SBFD and a second index to a second table or list of parameters for non-SBFD for determining the ROs). The WTRU may determine the active mode of operation to be SBFD and/or transmit a PRACH, for example if the CLI is lower than the PRACH CLI threshold. The WTRU may transmit the PRACH using an RO from the Ros that may be used for SBFD mode based on the configuration (e.g., an RO based on the first table or list). An RO (e.g., use of an RO) indicated for use with SBFD may (e.g., implicitly) indicate to the gNB that the WTRU supports SBFD operation. The WTRU may transmit a preamble in the RO. The preamble may indicate (e.g., is from a set that indicates) to the gNB that the WTRU supports a SBFD operation. The WTRU may transmit the PRACH using an RO from the ROs that may be used for non-SBFD mode based on the configuration (e.g., an RO based on the second table or list), for example when the first available SBFD RO is later than (e.g., more than a threshold amount of time or time units later than) the first available non-SBFD RO.

The WTRU may transmit a preamble in the RO. The preamble may indicate (e.g., is from a set that indicates) to the gNB that the WTRU supports SBFD operation. The WTRU may perform one or more of transmitting a preamble in the RO (e.g., that does not inform the gNB that the WTRU supports SBFD), monitoring for RAR (e.g., based on non-SBFD operation), and/or indicating its support for SBFD, for example separately from the preamble transmission (e.g., in Msg3 or a PUSCH transmitted based on the UL grant in the RAR or another UL grant). The WTRU may transmit a MsgA that includes the PRACH preamble and/or a PUSCH, for example for the case of 2-step RA. The WTRU may include an indication that it supports SBFD in the PUSCH (e.g., part) of the MsgA. The WTRU may determine the active mode of operation to be non-SBFD and/or transmit a PRACH using an RO from the ROs that may be used for non-SBFD mode based on the configuration (e.g., an RO based on the second table or list), for example if the CLI is higher than the PRACH CLI threshold.

A WTRU may select 2-step or 4-step RA. A WTRU (e.g., an SBFD-capable WTRU) may select a cell (e.g., as the suitable cell) (e.g., during initial access and/or cell (re)selection procedure). The WTRU may select an SSB (e.g., SSB beam) as the best SSB in the cell. The WTRU may transmit a PRACH preamble to the selected cell, that for example may be associated with the selected SSB.

A WTRU may receive a first PRACH CLI threshold and/or one or more configurations (e.g., via MIB, SIB, and so forth), for example on one or more reference signals and/or time and frequency resources to measure the CLI (e.g., CLI-RSSI). The WTRU may measure the CLI (e.g., CLI-RSSI) using the configured reference signal(s) and/or time and frequency resources. The WTRU may compare the measured CLI with the configured first PRACH CLI threshold. The WTRU may determine that the measured CLI is less than the configured first PRACH CLI threshold. The WTRU may determine to use the 2-step random access (RA), if for example the WTRU determines that the measured CLI is less than the configured first PRACH CLI threshold. The WTRU may use one or more measured parameters (e.g., RSRP (e.g., SS-RSRP) and/or CLI (e.g., CLI-RSSI), and so forth) to determine the random-access technique to be based on 2-step RA. For example, the WTRU may determine the random-access technique based on RSRP and CLI; and/or based on RSRP. The WTRU may determine to use 2-step RA if the measured RSRP is above a corresponding RSRP threshold and/or the measured CLI is below the PRACH CLI threshold. The WTRU may determine to use 2-step RA if the measured RSRP is above a corresponding RSRP threshold.

The WTRU may determine that the measured CLI exceeds than the configured first PRACH CLI threshold. The WTRU may determine to use the 4-step random access (RA), for example if the WTRU determines that the measured CLI exceeds than the configured first PRACH CLI threshold. The WTRU may use one or more measured parameters (e.g., RSRP (e.g., SS-RSRP), CLI (e.g., CLI-RSSI), and/or etc.) to determine the random-access technique to be based on 4-step RA. For example, the WTRU may determine the random-access technique based on RSRP and CLI; and/or based on RSRP (e.g., fallback). The WTRU may determine to use 4-step RA, for example if the measured RSRP is below a corresponding RSRP threshold and/or the measured CLI is above the PRACH CLI threshold. The WTRU may determine to use 4-step RA, for example if the measured RSRP is below a corresponding RSRP threshold.

The WTRU may transmit a configured, selected, and/or determined PRACH preamble to the cell. The WTRU may transmit a configured, selected, and/or determined PRACH preamble to the cell, for example if the WTRU determines to use the 4-step RA. The WTRU may monitor for a DL message (e.g., PDCCH) (e.g., indicating a RAR message), for example after sending the PRACJ preamble. The DL message may provide an UL grant, for example after sending the PRACH preamble. The WTRU may send an UL message and/or indication (e.g., in a PUSCH), for example based on the UL grant.

The WTRU may transmit a MsgA that, for example may include a configured, selected, and/or determined PRACH preamble. The WTRU may transmit a PUSCH carrying a message to the cell. The WTRU may transmit a MsgA that may include a configured, selected, and/or determined PRACH preamble, and a PUSCH carrying a message to the cell, for example if the WTRU determines to use the 2-step RA. The WTRU may monitor for a DL message (e.g., PDCCH) (e.g., indicating a MsgB), for example after sending MsgA. The DL message may include (e.g., at least) an RAR and/or may include contention resolution information.

A WTRU may indicate active mode of operation based on a PRACH transmission. A WTRU (e.g., an SBFD-capable WTRU) may select a cell (e.g., as the suitable cell) (e.g., during initial access and/or cell (re) selection procedure). The WTRU may select an SSB (e.g., SSB beam) as the best SSB in the cell. The WTRU may transmit a PRACH preamble to the selected cell, that for example may be associated with the selected SSB.

A WTRU may receive one or more of a PRACH CLI threshold, one or more configurations (e.g., via MIB, SIB, and so forth) on one or more reference signals, and/or time and/or frequency resources to measure the CLI (e.g., CLI-RSSI). The WTRU may be configured with a first PRACH CLI threshold, for example for determining 2-step RA or 4-step RA. The WTRU may be configured with a first PRACH CLI threshold, for example when a PRACH CLI threshold is used for determining whether to use 2-step RA or 4-step RA. The WTRU may be configured with a second PRACH CLI threshold. The second PRACH threshold may be used to determine the active mode of operation in transmission of the PRACH in the selected cell among a first mode of operation (e.g., SBFD) and/or a second mode of operation (e.g., without SBFD).

The WTRU that has selected the mode of operation to be SBFD in the selected cell, may select and/or determine to transmit a PRACH preamble in configured SBFD resources (e.g., via SIB1) (e.g., in UL subbands within an SBFD symbol) and/or in time units without SBFD operation (e.g., in UL and/or flexible symbols, slots, and so forth). The second PRACH CLI threshold may represent the existing CLI in UL subbands of the SBFD symbols in the selected cell. For example, if the measured CLI is higher that the threshold, this implies that CLI level is already higher than acceptable levels and that the gNB may not want to increase the CLI by sending (e.g., another) PRACH in UL subbands in SBFD symbols. The first and second thresholds may be the same or different and/or one threshold may be used for both determinations.

The WTRU may receive configuration information (e.g., via MIB, SIB, etc.). The configuration information may indicate resources in time and/or frequency, for example for one or more random-access occasions (RO). The configuration information may indicate resources (e.g., ROs), for example that may be used when the active mode of operation is SBFD. The configuration information may additionally, or alternatively, indicate the resources (e.g., ROs), for example that may be used when the active mode of operation is non-SBFD.

The configuration may include an index to a first and/or second table and/or list of parameters. The WTRU may use the index to find the RO transmission resources from the first table and/or the first list of parameters (e.g., SBFD resources), for example in case the WTRU determines the active mode of operation is SBFD. The WTRU may determine that the active mode of operation is non-SBFD. The WTRU may use the configured index to find the RO transmission resources from the second table and/or second list of parameters (e.g., non-SBFD resources). The time and frequency configurations in the first and/or second tables and/or list of parameters may be (pre) configured. Alternatively, or additionally, the WTRU may determine the values corresponding to the second and/or first table and/or list of parameters based on the first and/or second table or list of parameters, respectively, and/or based on a (pre)configured rule. The WTRU may determine the time resources and/or frequency resources for the second and/or first table or list of parameters, for example by using one or more offset values in time and/or frequency with regards to the first and/or second table or list of parameters, respectively.

The WTRU may measure the CLI (e.g., CLI-RSSI) using the configured reference signal(s) and/or time and frequency resources. The WTRU may compare the measured CLI with the configured second PRACH CLI threshold. In some examples, the WTRU may determine that the measured CLI is less than the second PRACH CLI threshold. The WTRU may determine the active mode of operation in the cell to be SBFD operation, for example if the WTRU determines that the measured CLI is less than the second PRACH CLI threshold. The WTRU may determine to send the PRACH preamble in configured time and/or frequency resources for RA, for example based on the configured index to the RA first and/or second table or list of parameters. The WTRU may determine to send the PRACH preamble based on a configured index to the first table and/or list of parameters; and/or based on a configured index to the second table and/or list of parameters.

The WTRU may (e.g., use) be configured with a configured index (e.g., an index) to the first table or list of parameters. The WTRU may transmit the selected and/or configured PRACH preamble using an RO from the ROs that may be used for SBFD mode and/or SBFD resources (e.g., UL subband in an SBFD symbol), for example based on the configuration (e.g., an RO based on the first table or list of parameters). The WTRU may (e.g., implicitly) indicate the mode of operation to be the first mode (e.g., SBFD), for example by transmitting the PRACH preamble in the resources that are configured for SBFD transmission (e.g., UL subbands in an SBFD symbol). The gNB may determine that the WTRU supports SBFD, and/or that the WTRU is SBFD-capable. The gNB may additionally, or alternatively, determine that the WTRU has selected and/or determined the active mode of operation to be based on SBFD. The WTRU may monitor for receiving DL messages and/or indications (e.g., PDCCH, RAR, and so forth), for example in the time and frequency resources corresponding to SBFD resources (e.g., as described herein). The WTRU may select and/or transmit a PRACH preamble in the configured RO resources. The PRACH preamble may be selected from a (pre)configured set. The (pre)configured set may indicate that the WTRU supports SBFD operation and/or that the WTRU has selected the SBFD operation as its active mode of operation. The WTRU may monitor for receiving DL messages and/or indications (e.g., PDCCH, RAR, and so forth) in the time and frequency resources corresponding to SBFD resources (e.g., as described herein), for example after transmitting the PRACH preamble.

The WTRU may be configured with (e.g., use) a configured index (e.g., an index) to the second table and/or list of parameters. In an example, the WTRU may transmit the selected and/or configured PRACH preamble using an RO from the ROs that may be used for non-SBFD mode and/or non-SBFD resources (e.g., TDD UL and/or TDD flexible symbols), for example based on the configuration (e.g., an RO based on the second table or list of parameters). The WTRU may determine to send the PRACH preambles based on second table or list of parameters (e.g., despite supporting SBFD operation). The WTRU may determine to transmit PRACH preambles based on second table and/or list of parameters, for example when the first available SBFD RO is later than (e.g., more than a threshold amount of time or time units later than) the first available non-SBFD RO. In other examples, the WTRU may select and/or transmit a PRACH preamble in the configured RO resources based on the second table.

The PRACH preamble may be selected from a (pre)configured set. The (pre)configured set may indicate that the WTRU supports SBFD operation and/or that the WTRU has selected the SBFD operation as its active mode of operation. The WTRU may monitor for receiving DL messages and/or indications (e.g., PDCCH, RAR, and so forth) in the time and frequency resources corresponding to SBFD resources (e.g., as described herein), for example after transmitting the PRACH preamble. The WTRU may (e.g., otherwise) select and/or transmit a PRACH preamble in the determined RO, for example based on the second table (e.g., that the PRACH preamble does not inform the gNB that the WTRU supports SBFD). The gNB may not (e.g., may not be able to) determine if the WTRU supports SBFD operation and/or may consider the WTRU operating without SBFD. The WTRU may monitor for receiving DL messages and/or indications (e.g., PDCCH, RAR, and so forth) in the time and frequency resources corresponding to non-SBFD resources (e.g., as described herein), for example after transmitting the PRACH preamble. The WTRU may indicate its support for SBFD separately from the preamble transmission (e.g., in Msg3 or a PUSCH transmitted based on the UL grant in the RAR or another UL grant). The WTRU may transmit a MsgA that may include the PRACH preamble and/or a PUSCH, for example for the case of 2-step RA. The WTRU may include an indication that it supports SBFD in the PUSCH part of the MsgA.

Alternatively, or additionally, a WTRU may determine that the measured CLI exceeds the second PRACH CLI threshold. The WTRU may determine the active mode of operation in the cell to be non-SBFD operation, for example based on the WTRU determining that the measured CLI exceeds the second PRACH CLI threshold. The WTRU may determine to send the PRACH preamble in configured time and/or frequency resources for RA, for example based on the configured index to the RA second table or list of parameters. The WTRU may monitor for receiving DL messages and/or indications (e.g., PDCCH, RAR, and so forth) in the time and frequency resources corresponding to non-SBFD resources (e.g., as described herein), for example after transmitting the PRACH preamble.

A WTRU may report CLI through initial access. A WTRU (e.g., an SBFD-capable WTRU) may select a cell (e.g., as the suitable cell) (e.g., during initial access and/or cell (re)selection procedure). The WTRU may select an SSB (e.g., SSB beam) as the best SSB in the cell. The WTRU may measure the interference (e.g., CLI), for example for the cell based on one or more received configurations. The WTRU may receive one or more indications by the information content that the WTRU has determined, detected, decoded, and/or received for the detected SSBs of the cell (e.g., from the serving cell or the cell WTRU is already camping on, e.g., via the MIB, SIB, DCI, MAC-CE, RRC, and so forth). The indication may include the cell-ID and/or the component carrier (CC) for which the CLI is measured in addition, or alternatively to, one or more reference signals (e.g., zero-power and/or non-zero-power RS), time, and/or frequency resources for measuring the CLI. The WTRU may receive one or more thresholds (e.g., RSRP, RSRQ, CLI, and/or etc.). The WTRU may measure the CLI (e.g., CLI-RSSI) based on one or more of the received configurations. The WTRU may transmit a PRACH preamble to the selected cell, that for example may be associated with the selected SSB.

A WTRU may indicate and/or report the measured CLI (e.g., CLI-RSSI), for example as part of the initial access procedure (e.g., PRACH preamble, Msg3, MsgA, and so forth). The WTRU may report the measured CLI value. Additionally, or alternatively, the WTRU may compare the measured CLI with a (pre)configured threshold. For example, if the measured CLI is higher than the (pre)configured threshold, the WTRU may indicate the CLI value (e.g., to a gNB). One or more PRACH preambles may be associated with CLI level. One or more random access (RO) resources may be associated with CLI level. The WTRU may report CLI-RSSI as part of random access Msg3/MsgA. There may be an association of one or more PRACH preambles with CLI Level. For example, the WTRU may compare the measured CLI with a configured CLI threshold and/or select the PRACH preamble based on the CLI level. The WTRU may select the PRACH preamble from a first set (e.g., preamble Type A), for example if the measured CLI is lower than the configured CLI threshold. The WTRU may determine to select the PRACH preamble from a second set (e.g., preamble Type B), for example if the measured CLI is higher than the configured CLI threshold. There may be an association of one or more random access (RO) resources with CLI Level. For example, the WTRU may compare the measured CLI with a configured CLI threshold and/or select the time and/or frequency resources to transmit the RO based on the CLI level. The WTRU may use, select, and/or determine the RO resources from a first set of time and/or frequency resources, for example if the measured CLI is lower than the configured threshold. The WTRU may use, select, and/or determine the RO resources to send PRACH on a second set of time and/or frequency resources, for example if the measured CLI is higher than the configured threshold. The WTRU may report CLI-RSSI as part of random access Msg3/MsgA. For example, the WTRU may report the measured CLI value and/or transmit (e.g., send) an indication, for example if the measured CLI is higher that a configured CLI threshold as part of Msg3/MsgA in random access procedure.

The WTRU may receive an indication from the cell to enable/disable the WTRU. For example, the WTRU may receive an indication from the cell to enable/disable the WTRU to report CLI value or CLI level, for example as part of the initial access procedure (e.g., via association of PRACH preambles, RO resources, or Msg3/MsgA). The indication may include one or more of an explicit indication and/or an implicit indication. An explicit indication may be, for example via one or more of MIB, SIB, and/or etc. There may additionally, or alternatively, be an implicit indication. For example, the WTRU may receive an indication on the threshold for the potential Msg3 size (e.g., UL data available for transmission plus MAC subheader(s) and/or where required, MAC CEs). The WTRU may determine to include the CLI reporting as part of Msg3 reporting, for example if the Msg3 size is higher than the configured threshold (e.g., ra-Msg3SizeGroupA).

The WTRU may determine to include the CLI reporting as part of initial access reporting, for example if the WTRU determines that a (pre) defined event and/or condition is triggered due to the L1/L2 CLI measurement (e.g., measured CLI higher than a (pre)configured threshold). The WTRU may monitor the DL messages (e.g., for receiving RAR) in time and/or frequency resources, for example that correspond to SBFD symbols. The WTRU may additionally, or alternatively, monitor the DL messages (e.g., for receiving RAR) in time and/or frequency resources, for example that correspond to non-SBFD symbols (e.g., TDD DL or TDD flexible time units). The WTRU may determine to include the CLI reporting as part of initial access reporting, for example if the WTRU detects the RAR indication in time and/or frequency resources that correspond to SBFD operation.

Alternatively, or additionally, the WTRU may report the CLI connecting to the cell and/or switching to RRC-connected mode. The WTRU may send an SR (e.g., to the gNB), for example for CLI measurement and/or reporting the measured CLI. The WTRU may receive one or more CLI reporting configurations (e.g., reference signals to measure CLI and/or time and frequency resources to report the CLI).

A gNB may reject the WTRU camping on a cell with SBFD operation. A WTRU may determine to camp on a cell (e.g., based on at least one of: measured and/or evaluated RSRP, RSRQ, the cell ranking, and in case the measured CLI<first threshold, or if the first CLI threshold is not broadcasted). The WTRU may transmit (e.g., send) PRACH on SBFD RO time and/or frequency resources and/or on non-SBFD resources (e.g., where the preamble indicates that WTRU supports SBFD). The WTRU may monitor and/or attempt to detect a DCI (e.g., with RA-RNTI or another RNTI) corresponding to a random-access response (RAR) within the period of RAR-window, for example after transmission of the PRACH. RAR may indicate acceptance of SBFD (e.g., RAR received with matching RAPID (e.g., via DCI using RA-RNTI), for example, when the WTRU receives the RAR (e.g., within the RAR window). RAR may indicate rejection for SBFD (e.g., that is the corresponding cell (gNB) has not accepted the WTRU to connect to it in SBFD operation (e.g., due to CLI level or EPRE reduction experienced by WTRU, due to a load-balancing purpose at the network side)), for example, when the WTRU receives the RAR (e.g., within the RAR window). RAR may indicate acceptance of SBFD (e.g., RAR received with matching RAPID (e.g., via DCI using RA-RNTI). For example, RAR may be received within the RAR reception time limit (e.g., window).

A random access preamble identifier (RAPID) may be included in the RAR. The RAPID may match the index of the preamble transmitted by the WTRU and/or may indicate acceptance of SBFD (e.g., for the WTRU). RAR may indicate rejection for SBFD (e.g., that is the corresponding cell (gNB) has not accepted the WTRU to connect to it in SBFD operation (e.g., due to CLI level or EPRE reduction experienced by WTRU, due to a load-balancing purpose at the network side)). For example, there may be cell-common rejection signaling. The RAR may be received with a (pre)configured information content (RAPID). For example, the WTRU may receive RAR based on a DCI with the WTRU's computed RA-RNTI (e.g., based on where and/or when the PRACH was transmitted) within the RAR reception time limit. The RAPID in RAR may be a (pre)configured value (e.g., value for index FFFF). The (pre)configured value may not match the index of the preamble used by the WTRU (e.g., RAPID). For example, the WTRU may determine that the received indication indicates an SBFD rejection signal.

There may be rejection signaling. There may be WTRU-specific rejection signaling. The WTRU may receive a RAR and/or other message, for example based on a DCI using a rejection RNTI (e.g., RJ-RNTI) (e.g., that is (pre)configured or a pre-defined RNTI). The DCI (e.g., using RJ-RNTI) may include one or more of information on other recommended cell(s) that the WTRU may try to send a second PRACH to and/or a second threshold that the WTRU may compare for a second CLI measurement. The WTRU may transmit a second PRACH to the cell, for example if the second CLI measurement for the cell satisfies with the second threshold.

The WTRU may determine to connect to the cell in non-SBFD operation (e.g., sends a PRACH associated with non-SBFD operation (e.g., using a non-SBFD preamble and/or non-SBFD resources)), for example after receiving an RAR and/or RNTI indicating SBFD rejection. The WTRU may choose a second cell (e.g., based on information received in the rejection RAR) and/or transmit a PRACH preamble (e.g., Msg1) to the second cell, for example after receiving an RAR and/or RNTI indicating SBFD rejection. The WTRU may determine to not consider the cell as a candidate for SBFD operation (e.g., the WTRU adds the cell to a list of conditional barred cells for SBFD operation (e.g., for a (pre)configured time duration)), for example after receiving an RAR and/or RNTI indicating SBFD rejection. There may be conditional barred cells for SBFD operation as discussed herein. The WTRU may transmit a message (e.g., Msg3 or RRC connection request or resume), for example after receiving an RAR that indicates or is associated with acceptance. The message (e.g., Msg3 or RRC connection request or resume) may be based on scheduling information (e.g., UL grant), for example provided by the RAR.

A gNB may reject the WTRU from camping on a cell with SBFD operation. The WTRU may determine to camp on a cell (e.g., based on at least one of: measured and/or evaluated RSRP, RSRQ, the cell ranking, and in case the measured CLI<first threshold, or if the first CLI threshold is not broadcasted). Additionally, or alternatively, the WTRU may transmit (e.g., send) PRACH on SBFD RO time and/or frequency resources and/or on non-SBFD resources (e.g., where the preamble indicates that WTRU supports SBFD). Additionally, or alternatively, the WTRU may monitor and/or attempt to detect a DCI (e.g., with RA-RNTI or another RNTI) corresponding to a random-access response (RAR) within the period of RAR-window, for example after transmission of the PRACH. Additionally, or alternatively, the WTRU may receive the RAR. When the WTRU receives the RAR (e.g., within the RAR window), for example, the RAR may indicate acceptance of SBFD (e.g., RAR received with matching RAPID (e.g., via DCI using RA-RNTI)). For example, the RAR may be received within the RAR reception time limit (e.g., window).

A RAPID may be included in the RAR. The RAPID may match the index of the preamble transmitted by the WTRU and/or may indicate acceptance of SBFD (e.g., for the WTRU). The RAR may indicate rejection for SBFD, (e.g., the corresponding cell (gNB) has not accepted the WTRU to connect to it in SBFD operation (e.g., due to CLI level or EPRE reduction experienced by WTRU, due to a load-balancing purpose at the network side)). There may be cell-common rejection signaling. The RAR may be received with a (pre)configured information content (RAPID). For example, the WTRU may receive RAR based on a DCI with the WTRU computed RA-RNTI (e.g., based on where and/or when the PRACH was transmitted). The WTRU may receive the RAR within the RAR reception time limit. A RAPID in RAR may include (e.g., be) a (pre)configured value (e.g., value for index FFFF). The (pre)configured value, for example, may not match the index of the preamble used by the WTRU (e.g., RAPID). The WTRU may determine that the received indication indicates an SBFD rejection signal.

There may be WTRU-specific rejection signaling. For example, the WTRU may receive a RAR and/or other message based on a DCI, for example using a rejection RNTI (e.g., RJ-RNTI) (e.g., that is (pre)configured or a pre-defined RNTI). The DCI contents in the DCI using RJ-RNTI may include one or more of information on other recommended cell(s) that the WTRU may try to send a second PRACH to and/or a second threshold that the WTRU may compare for a second CLI measurement. The WTRU may transmit a second PRACH to the cell, for example if the second CLI measurement for the cell satisfies with the second threshold. The WTRU may choose a second cell (e.g., based on information received in the rejection RAR) and/or transmit a PRACH preamble (e.g., Msg1) to the second cell, for example after receiving an RAR and/or RNTI indicating SBFD rejection. The WTRU may determine to connect to the cell in non-SBFD operation (e.g., sends a PRACH associated with non-SBFD operation (e.g., using a non-SBFD preamble and/or non-SBFD resources)), for example after receiving an RAR and/or RNTI indicating SBFD rejection. The WTRU may determine to not consider the cell as a candidate for SBFD operation (e.g., the WTRU adds the cell to a list of conditional barred cells for SBFD operation (e.g., for a (pre)configured time duration)), for example after receiving an RAR and/or RNTI indicating SBFD rejection. There may be conditional barred cells for SBFD operation as discussed herein. Additionally, or alternatively, the WTRU may transmit a message (e.g., Msg3 or RRC connection request or resume) based on scheduling information (e.g., UL grant) provided by the RAR, for example after receiving an RAR that indicates or is associated with acceptance.

A WTRU (e.g., an SBFD-capable WTRU) may select a cell (e.g., as the suitable cell) to camp on (e.g., during initial access and/or cell (re)selection procedure). In an example, the WTRU may select the cell based on one or more of measured parameters (e.g., measured and/or evaluated RSRP, RSRQ), the cell ranking configurations, the measured and/or evaluated interference (e.g., measured CLI less than a (pre)configured threshold, if the first CLI threshold is not broadcasted), and/or etc. The WTRU may select an SSB (e.g., SSB beam) as the best SSB in the cell. The WTRU may transmit a PRACH preamble to the selected cell (e.g., that is associated to the selected SSB). The WTRU may indicate its determined and/or selected active mode of operation (e.g., SBFD operation) via transmitting (e.g., sending) PRACH for example (e.g., via sending PRACH on SBFD RO time and frequency resources and/or via using the PRACH preamble selected from a first set that indicates that the WTRU supports SBFD, e.g., as described herein).

A WTRU may determine the mode of operation (e.g., operation with or without SBFD) based on the received random-access response (RAR). The WTRU may monitor and/or attempt to detect a DL message or indication (e.g., DCI with RA-RNTI or another RNTI) corresponding to a random-access response (RAR) within the period of an RAR-window or limit, for example after transmission of the PRACH.

RAR may indicate acceptance for using SBFD. The WTRU may determine that the received RAR (e.g., received within the RAR reception time window or limit) may indicate that the gNB has accepted the WTRU to connect to the cell and/or to operate in SBFD operation. The WTRU may determine that the received RAR message includes a RAPID that matches the RAPID and/or a preamble transmitted by the WTRU. The WTRU may receive the indication via RAR, for example based on one or more of an implicit indication and/or an explicit indication.

The indication may be an implicit indication. For example, reception of the RAR itself may indicate that the gNB has accepted the WTRU to camp on the cell, and/or that the active mode of operation may be SBFD. Reception of RAR in time and frequency resources corresponding to SBFD operation may (e.g., implicitly) indicate that the gNB has accepted the WTRU to camp on the cell, and/or that the active mode of operation may be SBFD. The indication may be an explicit indication. For example, the WTRU may receive an explicit indication (e.g., a flag indication) included in the RAR (message) and/or included in the DCI scheduling the PDSCH carrying the RAR. The WTRU may determine that the gNB has accepted the WTRU to camp on the cell, and/or that the active mode of operation may be SBFD, for example based on (e.g., using) the explicit indication.

Additionally, or alternatively, the RAR may indicate rejection for SBFD. For example, the WTRU may determine that the received RAR (e.g., received within the RAR reception time window or limit) may indicate that the gNB has not accepted that the WTRU with active mode of operation to be SBFD to connect to the cell. The WTRU may determine (e.g., based on the received RAR) that the gNB may not allow the WTRU to operate in SBFD mode of operation in the cell. For example, this may be due to CLI level and/or EPRE reduction experienced by WTRU and/or due to a load-balancing purpose at the network side.

The WTRU may receive the rejection signaling via one or more of rejection signaling (e.g., cell common rejection signaling); rejection signaling (e.g., WTRU-specific rejection signaling); and/or rejection signaling (e.g., WTRU-specific rejection signaling). The rejection signaling may be cell common rejection signaling. The WTRU may determine that the received RAR includes one or more (pre) configured information content that, for example may indicate the SBFD rejection signaling. The rejection signaling may be group-based rejection signaling and/or cell-common rejection indication. The WTRU may receive a RAR based on a DCI, for which for example the CRC in the DCI may be scrambled with a first RNTI (e.g., WTRU's computed RA-RNTI, e.g., based on where and when the PRACH was transmitted) and/or a second RNTI (e.g., a (pre)configured RNTI that may be associated with SBFD acceptance or rejection) within the RAR reception time window or limit. The WTRU may determine that the RAPID (e.g., the preamble index) included in the RAR is based on a (pre) defined or (pre)configured value (e.g., value for index 0 or FFFF) and/or that the RAPID does not match the index of the preamble transmitted by the WTRU. The WTRU may determine that the received RAPID matches a (pre)configured preamble index and/or that it indicates an SBFD rejection signaling.

Rejection signaling may be WTRU-specific rejection signaling. For example, the WTRU may determine that the received RAR includes one or more (pre)configured information content that, for example may indicate the SBFD rejection signaling. The rejection signaling may be a WTRU-specific rejection indication. For example, the WTRU may receive a RAR, and/or another message based on a DCI. The DCI may be scrambled with a rejection RNTI (e.g., RJ-RNTI) (e.g., that is (pre)configured or pre-defined RNTI). The DCI, RAR, and/or another message may indicate the index of the preamble (e.g., RAPID), for example transmitted by the WTRU. The WTRU may determine that the message was intended for the WTRU (e.g., based on the matching the received RAPID with the preamble index transmitted by the WTRU). The WTRU may determine that the received signaling indicates an SBFD rejection signaling. The DCI, RAR, and/or other message may include one or more of information on other recommended cell(s) that the WTRU may try to send a second PRACH and/or a second threshold (e.g., that the WTRU may compare for a second CLI measurement with). The WTRU may try to transmit (e.g., send) a second PRACH information on another recommended cell(s). The WTRU may receive one or more information content on one or more cells (e.g., suggested by the gNB), for example to monitor for cell (re) selection and/or to send PRACH to camp on the cell(s). There may be a second threshold, for example that the WTRU may compare for a second CLI measurement. The WTRU may transmit a second PRACH to the cell, for example if the second CLI measurement for the cell satisfies the second threshold (e.g., second measured CLI is lower than the second CLI threshold). Rejection signaling may include (e.g., be) a WTRU-specific rejection signaling. For example, the WTRU may receive a rejection indication via an indicator (e.g., a flag indication). The indicator may be included in the RAR and/or included in the DCI scheduling the PDSCH carrying the RAR (e.g., when the RAR includes a RAPID that matches the index of the preamble transmitted by the WTRU). The WTRU may determine that the received indication indicates an SBFD rejection signaling.

The WTRU may conditionally bar cells for SBFD operation, perform a non-SBFD operation, and/or select a second cell, for example after receiving an SBFD rejection indication from a cell (e.g., via DCI, RAR, RNTI (e.g., RJ-RNTI). The WTRU may perform a conditional barred cell(s) for SBFD operation. For example, the WTRU may determine to not consider the cell as a candidate for SBFD operation (e.g., during periodic cell search and/or cell (re)selection procedure). Additionally, or alternatively, the WTRU may add the cell to a list of conditional barred cells for SBFD operation (e.g., for a (pre)configured time duration). The WTRU may measure and/or detect conditional barred cells for SBFD operation, for example as described herein.

The WTRU may perform a non-SBFD operation. For example, the WTRU may determine to connect to the cell in non-SBFD mode of operation. The WTRU may determine that (e.g., consider) the cell as a candidate cell for non-SBFD operation (e.g., during periodic cell search and/or cell (re) selection procedure). The WTRU may send a PRACH preamble associated with non-SBFD operation (e.g., using a non-SBFD preamble and/or non-SBFD resources), for example if the cell is selected for cell selection (e.g., with highest cell ranking).

The WTRU may select a second cell. For example, the WTRU may choose a second cell (e.g., based on information received in the rejection RAR) and/or transmit a PRACH preamble (e.g., Msg1) to the second cell. Alternatively, or additionally, the WTRU may determine that the WTRU may perform SBFD operation in the cell, for example after receiving an RAR that indicates and/or is associated with acceptance to a cell. The RAR may be received in symbols overlapping with SBFD symbols (e.g., time and frequency resources corresponding to SBFD operation). The symbols may (e.g., implicitly) indicate the first mode of operation (e.g., SBFD operation) in the cell. The WTRU may transmit a message (e.g., Msg3 and/or RRC connection request or resume) based on scheduling information (e.g., UL grant) provided by the RAR.

There may be conditional acceptance of the WTRU to camp on a cell with SBFD operation, for example based on a tolerance window and/or timer. A WTRU may receive (e.g., via SIB) configuration information. The configuration information may indicate one or more resources and/or reference signals for CLI measurement. The WTRU may receive (e.g., via SIB) a time period (e.g., window) for SBFD barring (e.g., T_{SBFD-Barred}). The WTRU may receive (e.g., via SIB) a CLI threshold (e.g., TH_{SBFD-B}). The CLI threshold may be associated with SBFD barring (e.g., the threshold is the value below which the cell is not considered as an SBFD-barred cell).

The WTRU may transmit a signal, channel, message, and/or other transmission to a cell (e.g., using SBFD resources and/or indicating support for SBFD such as, for example transmitting a PRACH preamble in PRACH resources where the PRACH preamble and/or PRACH resources indicate SBFD support). The cell may include (e.g., be) the same cell as the cell from which the WTRU received one or more of the configuration information, the SBFD barring time period, and/or the CLI threshold. The WTRU may receive an SBFD rejection message and/or an indication (e.g., via RAR or RJ-RNTI) from the cell, for example in response to the WTRU transmitting the PRACH preamble to the cell. The message and/or indication may indicate that the cell is conditionally barred for SBFD operation. For example, an SBFD-conditionally-barred cell may not be used as an SBFD candidate cell for cell (re)selection for a minimum of T_{SBFD-Barred} time (e.g., a threshold). In another example, an SBFD-conditionally-barred cell may be used as an SBFD candidate cell for cell (re)selection after T_{SBFD-Barred} time has elapsed and/or the measured CLI is lower than the CLI threshold (e.g., TH_{SBFD-Barred}). The WTRU may begin (e.g., starts) a barring time period (e.g., initiates a timer) based on (e.g., equal to) the configured SBFD barring time period (e.g., T_{SBFD-Barred}). For example, the WTRU may begin (e.g., starts) a barring time period (e.g., initiates a timer) based on (e.g., equal to) the configured SBFD barring time period T_{SBFD-Barred} after receiving the SBFD-rejection indication or message.

The WTRU may perform cell ranking for cell (re)selection. Cell ranking may be determined based on whether or not the barring time period has ended (e.g., whether or not the timer expired), and/or a CLI measurement. If the barring time period has not ended (e.g., timer not expired) for example, the WTRU may perform cell ranking for cell (re)selection (e.g., during initial access or periodic cell search procedure) considering the cell to be invalid for SBFD operation. The WTRU may (e.g., still) consider the cell for non-SBFD operation. In another example, when the barring time period ends (e.g., timer expires) for example, the WTRU may measure the CLI based on the configured CLI measurement resources. If the measured CLI is lower than the configured CLI threshold (e.g., TH_{SBFD-B}) for example, the WTRU may consider the cell as an SBFD candidate in cell ranking for cell (re)selection procedure (e.g., during periodic cell search procedure). The WTRU may measure one or more parameters (e.g., RSRP, RSRQ, etc.) to determine the cell-ranking for the cell. The WTRU may select the cell or another cell and/or transmit (e.g., send) a PRACH according to SBFD and/or non-SBFD operation (e.g., depending on the selected cell). For example, based on cell ranking, the WTRU may select the cell or another cell and/or transmit (e.g., send) a PRACH according to SBFD and/or non-SBFD operation (e.g., depending on the selected cell).

There may be acceptance and/or conditional acceptance of the WTRU to camp on a cell with SBFD operation. There may be acceptance and/or conditional acceptance of the WTRU to camp on a cell with SBFD operation, for example based on a tolerance window and/or timer. The WTRU may receive (e.g., via SIB) configuration information. The configuration information may indicate one or more resources and/or reference signals for CLI measurement. Additionally, or alternatively, the WTRU may receive (e.g., via SIB) a time period (e.g., window) for SBFD barring (e.g., T_{SBFD-Barred}). Additionally, or alternatively, the WTRU may receive (e.g., via SIB) a CLI threshold (e.g., TH_{SBFD-B}) associated with SBFD barring, (e.g., the threshold is the value below which the cell is not considered as an SBFD-barred cell). Additionally, or alternatively, the WTRU may transmit a signal, channel, message, and/or other transmission to a cell (e.g., using SBFD resources or indicating support for SBFD such as transmitting a PRACH preamble in PRACH resources where the PRACH preamble and/or PRACH resources indicate SBFD support). For example, the cell may include (e.g., be) the same cell as the cell from which the WTRU received one or more of the configuration information, the SBFD barring time period and/or the CLI threshold. Additionally, or alternatively, the WTRU may receive an SBFD rejection message and/or indication (e.g., via RAR and/or RJ-RNTI) from the cell, for example in response to the WTRU transmitting the PRACH preamble to the cell. The message and/or indication may indicate that the cell is conditionally barred for SBFD operation. For example, an SBFD-conditionally-barred cell may not be used as an SBFD candidate cell for cell (re) selection for a minimum of T_{SBFD-Barred} time (e.g., a threshold). In another example, an SBFD-conditionally-barred cell may be used as an SBFD candidate cell for cell (re)selection after T_{SBFD-Barred} time has elapsed and/or the measured CLI is lower than the CLI threshold (TH_{SBFD-Barred}).

Additionally, or alternatively, the WTRU may begin (e.g., start) a barring time period (e.g., initiates a timer), for example based on (e.g., equal to) the configured SBFD barring time period T_{SBFD-Barred}. For example, after receiving the SBFD-rejection indication and/or message, the WTRU may begin (e.g., start) a barring time period (e.g., initiates a timer). The barring time period may be based on (e.g., equal to) the configured SBFD barring time period (e.g., T_{SBFD-Barred}). Additionally, or alternatively, the WTRU may perform cell ranking for cell (re)selection. The rank of the cell may be determined based on whether or not the barring time period has ended (e.g., whether or not the timer expired), and/or the CLI measurement. For example, If the barring time period has not ended (e.g., timer not expired), the WTRU may perform cell ranking for cell (re)selection (e.g., during initial access or periodic cell search procedure), for example considering the cell to be invalid for SBFD operation. The WTRU may still consider the cell for non-SBFD operation. The WTRU may measure the CLI based on the configured CLI measurement resources, for example, when the barring time period ends (e.g., timer expires). The WTRU may consider the cell as an SBFD candidate in cell ranking for cell (re)selection procedure (e.g., during periodic cell search procedure), for example if the measured CLI is lower than the configured CLI threshold (TH_{SBFD-B}). The WTRU may measure one or more parameters (e.g., RSRP, RSRQ, etc.), for example to determine the cell-ranking for the cell. The WTRU may select the cell or another cell and/or transmit (e.g., send) a PRACH according to SBFD and/or non-SBFD operation (e.g., depending on the selected cell). For example, based on cell ranking, the WTRU may select the cell or another cell and/or transmit (e.g., send) a PRACH according to SBFD and/or non-SBFD operation (e.g., depending on the selected cell).

There may be conditionally barred cells for a SBFD operation. A WTRU (e.g., an SBFD-capable WTRU) may detect one or more SS/PBCH blocks (SSB) from a cell (e.g., during cell search). The cell may be a candidate cell used for cell (re)selection. The WTRU may determine, detect, decode, and/or receive one or more information content corresponding to the detected SSBs of the cell (e.g., from the serving cell or the cell WTRU is already camping on, e.g., via the MIB, SIB, explicit message, and so forth). For example, the WTRU may determine (e.g., based on decoding the information content) that the cell supports and/or operates with SBFD operation (e.g., via a flag indication). The WTRU may receive a configuration regarding the cell (e.g., from the serving cell or the cell WTRU is already camping on (e.g., via the MIB, SIB, explicit message, and so forth), for example indicating the time units and the frequency resources (e.g., subbands, RBs, BWPs, and so forth). Additionally, or alternatively, WTRU may receive a configuration regarding the cell (e.g., from the serving cell or the cell WTRU is already camping on (e.g., via the MIB, SIB, explicit message, and so forth), for example where the first mode of operation (e.g., SBFD operation) is applied. The WTRU may receive a configuration, indicating the direction of UL/DL transmission and/or reception in the configured frequency resources.

The WTRU may measure the interference (e.g., CLI) for the cell based on one or more received configurations. The WTRU may receive one or more indications by the information content that the WTRU has determined, detected, decoded, and/or received for the detected SSBs of the cell (e.g., from the serving cell or the cell WTRU is already camping on, e.g., via the MIB, SIB, DCI, MAC-CE, RRC, and/or etc.). The indication may include the cell-ID and/or the component carrier (CC) for which the CLI is measured. The indication may additionally, or alternatively, include one or more reference signals (e.g., zero-power and/or non-zero-power RS), time resources, and/or frequency resources, for example for measuring the CLI. The WTRU may receive one or more thresholds (e.g., RSRP, RSRQ, CLI, and so forth). The WTRU may measure the CLI (e.g., CLI-RSSI), for example based on the received configurations.

The WTRU may perform cell ranking (e.g., based on RSRP, RSRQ, CLI, and so forth) and/or select the cell as the suitable cell to connect to and/or camp on with SBFD operation (e.g., based on the cell with highest ranking or based on the cell with highest selection priority). The WTRU may send a PRACH preamble to the cell, for example based on the selected mode of operation that is the SBFD operation. The WTRU may send the PRACH preamble in SBFD resources (e.g., based on received configuration on the time and frequency resources in SBFD) (e.g., UL subband in SBFD symbols). The WTRU may indicate (e.g., implicitly) that the WTRU supports SBFD and/or that the WTRU active mode of operation is SBFD. The WTRU may select and/or transmit (e.g., send) a PRACH preamble. The PRACH preamble may be from a (e.g., first) set of preambles. The (e.g., first) set of preambles may correspond to the SBFD configuration. Alternatively, or additionally, the PRACH preamble may indicate (e.g., implicitly) that the WTRU supports SBFD and/or that the WTRU active mode of operation is SBFD.

The WTRU may monitor and/or attempt to detect the random access response (RAR) message, for example within the period of an RAR-window and/or limit. After PRACH preamble transmission for example, WTRU may monitor and/or attempt to detect the random access response (RAR) message within the period of an RAR-window and/or limit. The WTRU may receive a RAR and/or other message (e.g., DCI with CRC scrambled with RJ-RNTI). The RAR and/or other message may indicate that the gNB has refused and/or rejected the WTRU to connect to the gNB with SBFD mode of operation (e.g., as described herein).

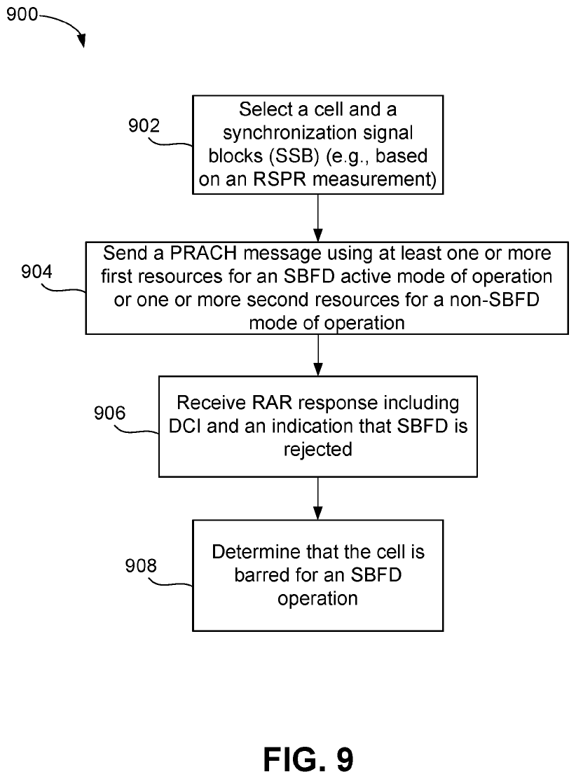

The WTRU may determine that the cell is conditionally barred for SBFD operation. FIG. 9 is a diagram illustrating an example procedure 900 for determining that a cell is barred from SBFD operation. For example, upon reception of the SBFD rejection signal, the WTRU may determine that the cell is conditionally barred for SBFD operation. The WTRU may be configured and/or receive one or more information content regarding the SBFD-conditionally-barred cell. In an example, the WTRU may receive one or more time period and/or window for SBFD-conditionally-barring (e.g., T_{SBFD-Barred}). The WTRU may receive one or more CLI thresholds (e.g., TH_{SBFD-B}) associated with the SBFD-conditionally-barred cell. The WTRU may receive the configurations as part of the SSB detection information content (e.g., via MIB, SIB, etc.) and/or via the receive RRC and/or the other message (e.g., DCI with CRC scrambled with RJ-RNTI).

The WTRU may stop the initial access procedure that was initiated toward the SBFD-conditionally-barred cell. The WTRU may stop the initial access procedure that was initiated toward the SBFD-conditionally-barred cell, for example after receiving the SBFD-rejection indication and/or message. The WTRU may switch the mode of operation to the operation without SBFD (e.g., non-SBFD operation). The WTRU may switch the mode of operation to the operation without SBFD (e.g., non-SBFD operation), for example if the WTRU was in the middle of an initial access to the cell. The WTRU may transmit a PRACH preamble in resources configured for non-SBFD operation (e.g., TDD DL, TDD UL, and/or TDD flexible time units and frequencies). The WTRU may stop the cell (re)selection procedure toward the cell. For example, if the WTRU was in the middle of a cell (re)selection procedure, the WTRU may stop the cell (re) selection procedure toward the cell. The WTRU may (re)start the (e.g., a new) cell (re) selection procedure and/or cell ranking, for example while considering the cell as a SBFD-conditionally-barred cell.

The WTRU may determine that the cell is barred from SBFD operation for a predetermined period of time, for example if the cell is barred from SBFD operation. The WTRU may determine to connect to the cell for a non-SBFD operation. The WTRU may select a second cell based on information received in the RAR and/or transmit a PRACH preamble to the second cell, for example if the cell includes a first cell.

The WTRU may start a barring time period (e.g., initiates a timer), for example based on (e.g., equal to) the configured SBFD barring time period (e.g., T_{SBFD-Barred}). The WTRU may start a barring time period (e.g., initiates a timer) based on (e.g., equal to) the configured SBFD barring time period (e.g., T_{SBFD-Barred}), for example after receiving the SBFD-rejection indication or message. Additionally, or alternatively, the WTRU may not use the SBFD-conditionally-barred cell as an SBFD candidate cell for cell (re) selection for a minimum time duration (e.g., T_{SBFD-Barred}). The WTRU may use the SBFD-conditionally-barred cell as a non-SBFD candidate cell (e.g., a candidate cell without SBFD operation) for cell (re) selection, for example for the minimum time duration (e.g., T_{SBFD-Barred}). The WTRU may measure the CLI (e.g., CLI-RSSI based on the configured reference signals and time and frequency resources). For example, when the timer (e.g., T_{SBFD-Barred}) has expired, the WTRU may measure the CLI (e.g., CLI-RSSI based on the configured reference signals and time and frequency resources). The WTRU may determine that the cell is no longer an SBFD-conditionally-barred cell. The WTRU may determine that the cell is no longer an SBFD-conditionally-barred cell, for example if the measured CLI is lower than the configured CLI threshold (e.g., TH_{SBFD-B}). The WTRU may (re)initiate and/or (re)start the barring time period based on the configured SBFD barring time period (e.g., T_{SBFD-Barred}), for example if the measured CLI is higher than the configured CLI threshold (e.g., TH_{SBFD-B}).

A WTRU that is performing cell ranking for cell (re)selection may determine the ranking of the cell based on whether the cell is an SBFD-conditionally-barred (e.g., based on the barring time window and/or the measured CLI). For example, the WTRU may determine that the barring time window has not ended (e.g., initiated timer has not expired). The WTRU may perform the cell ranking for cell (re)selection (e.g., during initial access or periodic cell search procedure) considering the cell to be invalid for SBFD operation, for example based on the determination that the barring time window has not ended. Additionally, or alternatively, the WTRU may consider (e.g., only consider) the cell for cell ranking in non-SBFD mode of operation.

The WTRU may determine that the barring window has ended (e.g., initiated timer has expired). The WTRU may measure the CLI (e.g., CLI-RSSI) based on the configured CLI measurement reference signals and/or time and frequency resources. The WTRU may determine to consider the cell as an SBFD candidate cell in cell ranking for cell (re)selection procedure (e.g., during periodic cell search procedure), for example if the measured CLI is lower than the configured CLI threshold (e.g., TH_{SBFD-B}). Alternatively, or additionally, the WTRU may determine to consider the cell as a SBFD-conditionally-barred cell and/or a non-SBFD candidate cell in cell ranking for cell (re)selection procedure (e.g., during periodic cell search procedure), for example if the measured CLI is higher than the configured CLI threshold (e.g., TH_{SBFD-B}).

At 902 a WTRU may select a cell and/or a synchronization signal block (SSB) associated with the cell, for example based on a reference signal received power (RSRP) measurement. At 904 the WTRU may send a physical random access channel (PRACH) message, for example using at least one of one or more first resources for an SBFD active mode of operation and/or one or more second resources for a non-SBFD active mode of operation. The PRACH message may include an indication that the WTRU supports SBFD. The WTRU may select the cell or another cell (e.g., to camp on) and/or may send a PRACH according to SBFD or non-SBFD operation (e.g., based on the determined mode of operation to be SBFD or non-SBFD), for example depending on the selected cell. The WTRU may select the cell or another cell (e.g., to camp on) and/or may send a PRACH according to SBFD or non-SBFD operation (e.g., based on the determined mode of operation to be SBFD or non-SBFD), for example depending on the selected cell. Additionally, or alternatively, the WTRU may select the cell or another cell (e.g., to camp on) and/or may send a PRACH, for example according to SBFD and/or non-SBFD operation, based on the determined cell ranking. Performing the cell ranking based on the SBFD-conditionally-barred cell(s) may provide benefits, for example in terms of latency reduction in accessing (e.g., camping) on a cell based on a selected SBFD and/or non-SBFD operation mode, and/or reliability enhancement based on comparing the measured CLI(s) with the one or more CLI thresholds.

There may be conditional acceptance for a WTRU in a cell (re)selection process, for example if the CLI is reduced after a time window. A WTRU may perform a cell (re)selection process. For example, the WTRU may determine whether to transmit a PRACH preamble (e.g., Msg1) to a first cell. The WTRU may transmit a signal, channel, message, and/or other transmission to the first cell. For example, the WTRU may transmit a signal, channel, message, and/or other transmission to the first cell using SBFD resources and/or indicating support for SBFD such as transmitting a PRACH preamble in PRACH resources where the PRACH preamble and/or PRACH resources indicate SBFD support.

The WTRU may receive a first indication, for example sent by the first cell, indicating a first CLI threshold regarding the cell (re)selection process (e.g., sent via SIB1, SIB2, etc.). The first indication may be sent via a broadcast message (e.g., MIB, SIB1, SIB2, etc., or a separate broadcast/multicast message), for example, from the first cell. Additionally, or alternatively, the WTRU may measure a CLI (e.g., L1/L2 CLI-RSSI, etc.). For example, the WTRU may measure a CLI (e.g., L1/L2 CLI-RSSI, etc.) based on the first indication. The WTRU may measure the CLI based on one or more measurement resources (e.g., determined by (e.g., indicated by, associated with) the first indication). Additionally, or alternatively, the WTRU may determine that the WTRU can camp on the first cell by transmitting the PRACH preamble (e.g., if the measured CLI is less than, or less than or equal to) the first CLI threshold. For example, in response to the determining, the WTRU may transmit the PRACH (e.g., preamble) to the first cell. The WTRU may receive a response message from the first cell.

The WTRU may receive the response message from the first cell. The response message may be based on indicating a conditional acceptance. The response message may include one or more parameters (e.g., for CLI threshold, timer, CLI measurement RS configuration applicable for the WTRU, and/or for the condition to be checked during a period of time for determining whether to stay in the first cell or not). At 906 the WTRU may receive a random access response (RAR). The RAR response may include downlink control information (DCI) and/or an indication that SBFD is rejected. At 908 the WTRU may determine that the cell is barred from an SBFD operation. For example, the WTRU may receive the conditional acceptance signaling via initial access signaling (e.g., RAR or Msg4) during initial access to the camping-on cell. There may be a benefit of avoiding ping-ponging and/or performing a fast handover (e.g., Layer1 (L1) or Layer2 (L2) mobility management). Additionally, or alternatively, robustness may be improved based on the WTRU indicating to the first cell that the WTRU is connected to the first cell, for example conditioned on that the CLI may be reduced during the period of time. Additionally, or alternatively, the WTRU may receive configuration on one or more of a first time window, a second time window, and/or so forth. The first time-window may be the minimum time to be considered to have a low CLI (e.g., T1). The second time window may be the maximum monitoring time (e.g., T2), and/or so forth. Additionally, or alternatively, the WTRU may measure and/or determine the CLI based on received CLI measurement resources (e.g., L1-CLI-RSSI, SB-wise CLI, and/or delta-CLI). The WTRU may initiate a timer. For example, on condition that the measured CLI is lower than a first threshold and higher than a second threshold, the WTRU may initiate a timer (e.g., T2).

The RAR may include a random access preamble identifier (RAPID). The WTRU may wherein determine that the cell is barred from SBFD operation based on the RAPID not matching an index of the WTRU. A DCI may include a rejection radio network temporary identifier (RJ-RNTI). The DCI may include an indication of a second cell for transmission of a PRACH preamble, for example if the cell includes a first cell. The DCI may include a threshold for a cross-link interference (SLI) measurement. The WTRU may compare the threshold to a CLI measurement. The WTRU may determine whether to transmit a second PRACH message to the second cell based on the comparison, for example if the PRACH message includes a first PRACH message.

Additionally, or alternatively, the WTRU may continue (e.g., or may be configured) to measure one or more CLIs on configured resources and/or RSs (e.g., periodically). The configured resources and/or RSs may be associated with the first cell and/or a second cell and/or TRP. Measuring a CLI, of the one or more CLIs, on at least one of the configured resources and/or RSs being associated with the second cell and/or TRP may include (e.g., imply) that the WTRU may perform a L1 and/or L2 based (e.g., fast) mobility management related procedure (e.g., that may be configured by the first cell), (e.g., a fast handover process). The WTRU may reset the timer. For example, on condition that the measured CLI is lower than the second CLI threshold for more than a minimum time indicated as first time-window (e.g., T1), the WTRU may reset the timer (e.g., T2).

The WTRU may determine to stay in the camped-on first cell. The WTRU may determine to stay in the camped-on first cell, for example based on the condition that the measured CLI is lower than the second CLI threshold for more than a minimum time indicated as first time-window (e.g., T1) and/or that the WTRU resets the timer (e.g., T2). The WTRU may determine and/or indicate to the gNB (e.g., the first cell or TRP) to not camp on the first cell and/or to request the fast handover process (e.g., the L1 and/or L2 based mobility management related procedure). For example, on condition that the timer has reached the maximum monitoring time-window (e.g., T2) and/or the measured CLI is still higher than the second CLI threshold, the WTRU may determine and/or indicate to the gNB (e.g., the first cell and/or TRP) to not camp on the first cell and/or to request the fast handover process (e.g., the L1 and/or L2 based mobility management related procedure). The fast handover process may reduce latency in handover and/or improve robustness in camping on a cell or TRP.

What is claimed is:

1-16. (canceled)

17. A method implemented by a wireless transmit/receive unit (WTRU), the method comprising:
selecting a cell and a synchronization signal block (SSB) associated with the cell based on a reference signal received power (RSRP) measurement;
receiving configuration information comprising a physical random access channel (PRACH) cross-link interference (CLI) threshold;
determining a CLI associated with the cell;
comparing the determined CLI with the PRACH CLI threshold;
determining, based on the comparison of the determined CLI with the PRACH CLI threshold and based on the RSRP measurement, whether to use 2-step random access or 4-step random access; and
transmitting, based on the determination of whether to use 2-step random access or 4-step random access, a PRACH message.

18. The method of claim 17, comprising determining to use 2-step random access based on the determined CLI being less than the PRACH CLI threshold.

19. The method of claim 18, comprising comparing the RSRP measurement to an RSRP threshold and determining to use 2-step random access based on the RSRP measurement being greater than the RSRP threshold.

20. The method of claim 17, comprising determining to use 4-step random access based on the determined CLI being greater than the PRACH CLI threshold.

21. The method of claim 20, comprising comparing the RSRP measurement to an RSRP threshold and determining to use 4-step random access based on the RSRP measurement being less than the RSRP threshold.

22. The method of claim 17, comprising:
determining an active mode of operation based on the comparison of the determined CLI to the PRACH CLI threshold;
determining the active mode of operation to be subband non-overlapping full duplex (SBFD) if the determined CLI is less than the PRACH CLI threshold; and
transmitting the PRACH message to a base station.

23. The method of claim 22, wherein the PRACH message comprises an indication that the active mode of operation of the WTRU is SBFD.

24. The method of claim 23, further comprising transmitting a preamble to the base station before transmitting the PRACH message, wherein the preamble indicates that the active mode of operation of the WTRU is SBFD.

25. The method of claim 17, comprising determining an active mode of operation for the WTRU to be subband non-overlapping full duplex (SBFD) if the determined CLI is less than the PRACH CLI threshold.

26. The method of claim 17, comprising determining an active mode of operation for the WTRU to be non-subband non-overlapping full duplex if the determined CLI is greater than the PRACH CLI threshold.

27. A wireless transmit/receive unit (WTRU) comprising a processor, the processor configured to:
select a cell and a synchronization signal block (SSB) associated with the cell based on a reference signal received power (RSRP) measurement;
receive configuration information comprising a physical random access channel (PRACH) cross-link interference (CLI) threshold;
determine a CLI associated with the cell;
compare the determined CLI with the PRACH CLI threshold;
determine, based on the comparison of the determined CLI with the PRACH CLI threshold and based on the RSRP measurement, whether to use 2-step random access or 4-step random access; and
transmit, based on the determination of whether to use 2-step random access or 4-step random access, a PRACH message.

28. The WTRU of claim 27, wherein the processor is configured to determine to use 2-step random access based on the determined CLI being less than the PRACH CLI threshold.

29. The WTRU of claim 28, wherein the processor is configured to compare the RSRP measurement to an RSRP threshold and determine to use 2-step random access based on the RSRP measurement being greater than the RSRP threshold.

30. The WTRU of claim 27, wherein the processor is configured to determine to use 4-step random access based on the determined CLI being greater than the PRACH CLI threshold.

31. The WTRU of claim 30, wherein the processor is configured to compare the RSRP measurement to an RSRP threshold and determine to use 4-step random access based on the RSRP measurement being less than the RSRP threshold.

32. The WTRU of claim 27, wherein the processor is configured to:
determine an active mode of operation based on the comparison of the determined CLI to the PRACH CLI threshold;
determine the active mode of operation to be subband non-overlapping full duplex (SBFD) if the determined CLI is less than the PRACH CLI threshold; and
transmit the PRACH message to a base station.

33. The WTRU of claim 32, wherein the PRACH message comprises an indication that the active mode of operation of the WTRU is SBFD.

34. The WTRU of claim 33, wherein the processor is configured to transmit a preamble to the base station before transmitting the PRACH message, wherein the preamble indicates that the active mode of operation of the WTRU is SBFD.

35. The WTRU of claim 27, wherein the processor is configured to determine an active mode of operation for the WTRU to be subband non-overlapping full duplex (SBFD) if the determined CLI is less than the PRACH CLI threshold.

36. The WTRU of claim 27, wherein the processor is configured to determine an active mode of operation for the WTRU to be non-subband non-overlapping full duplex if the determined CLI is greater than the PRACH CLI threshold.
